(19) United States
(12) Patent Application Publication
(10) Pub. No.: US 2013/0003075 A1
(43) Pub. Date: Jan. 3, 2013

(54) IMAGING APPARATUS

(75) Inventor: Hiroshi Kusumoto, Kokubunji-shi (JP)

(73) Assignee: CANON KABUSHIKI KAISHA, Tokyo (JP)

(21) Appl. No.: 13/533,115

(22) Filed: Jun. 26, 2012

(30) Foreign Application Priority Data
Jun. 30, 2011 (JP) 2011-146342
Apr. 10, 2012 (JP) 2012-089354

(51) Int. Cl. G01B 9/02

(52) U.S. Cl. 356/479

(57) ABSTRACT

In order to reduce a width in a scanning direction with respect to an arrangement of measurement lights and to obtain a tomogram with a high SN ratio, an imaging apparatus according to the present invention adjusts an arrangement of a plurality of measurement lights in an object to be examined with respect to a scanning direction of a scanning unit for scanning the object to be examined with the plurality of measurement lights, based on a detection result of a detection unit for detecting the arrangement of the plurality of measurement lights.

### BACKGROUND OF THE INVENTION

1. Field of the Invention

The present invention relates to an optical coherence tomography apparatus for acquiring a tomogram of an object to be examined.

2. Description of the Related Art

In recent years, optical coherence tomography apparatuses (OCT apparatus) utilizing technologies of low-coherence interferometer or white-light interferometer have been put into practical use. The OCT apparatuses have been used in the medical field, in particular, in the field of ophthalmology to obtain tomograms of fundus retinae. The OCT apparatuses use properties of light and thus can perform a measurement with a high resolution of micrometers which is the order of the wavelength of light.

In the OCT apparatuses, a plurality of tomograms is acquired a plurality of times at the same location of an object to be examined, and the acquired tomograms are averaged after the locations thereof are adjusted, and averaged, to secure a signal of high signal-to-noise ratio (hereinafter, referred to as “SN ratio”) and obtain a tomogram of high quality. Accordingly, random noise can be relatively reduced, and an SN ratio of a tomogram is improved.

However, when an object to be examined in the medical field is a living body, for example, in a fundus measurement, since an eye of a human body which is an object to be examined randomly moves slightly during measurement, a measured image is deformed if the measurement is completed at a high speed.

Japanese Patent Application Laid-Open No. 2010-188114 discusses a method of scanning an object by using measurement lights arranged in a scanning direction by using a plurality of light sources, and averaging data arrays at measurement sites where a measured object is the same to achieve a high speed.

This method is referred to as a tandem scan. Various patterns of scans such as vertical scans, transverse scans, and radial scans are required according to conditions of a disease in the clinical field. It is necessary to change arrangement angles of measurement lights to a fundus in order to perform a vertical scan, a transverse scan, or a radial scan to perform a tandem scan with a plurality of light sources.

In order to secure an image with a high SN ratio by a tandem scan, it is necessary to arrange measurement lights more parallel to the scanning direction and limit widths of the measurement lights with respect to the scanning direction produced by the measurement lights to a more infinitesimal range.

Recently, diameters of measurement lights are reduced, and imaging is performed with measurement lights of high NA to obtain an image of high resolution. Accordingly, it is necessary to limit the arrangement of measurement lights to a more infinitesimal range in the scanning direction.

Due to this, it is necessary to make an error between a scanning direction of a light scanning unit and arranging directions of measurement lights infinitesimal. It is necessary to drive the light scanning unit and adjust a relative location relationship of the measurement lights to make the error between the scanning direction of the light scanning unit and arranging directions of the measurement lights infinitesimal. Accordingly, an adjustment by an expert is necessary.

However, the light scanning unit is frequently moved due to vibration by movement of the OCT apparatus and the like.

Further, when a mechanism, such as an image rotator, for changing an arrangement angle of the measurement lights, is provided, the image rotator is guided to a predetermined location by using a sensor for obtaining a reference location of the image rotator, and the angle of the measurement light array is adjusted while taking the predetermined location as a starting point when the OCT apparatus is started. However, a variation between locations of the image rotator is generated when the image rotator is guided to a predetermined location.

Therefore, in order to restrain the dislocation between the scanning direction and the arrangement direction of the measurement lights within an infinitesimal range and to obtain an image with a high SN ratio, regular maintenance, or confirmation and adjustment by an expert is necessary when the OCT apparatus is started.

### SUMMARY OF THE INVENTION

The present invention is directed to an imaging apparatus capable of reducing a width of arrangement of measurement lights in a scanning direction and obtaining a tomogram with a high SN ratio.

According to an aspect of the present invention, there is provided an imaging apparatus for acquiring an image of an object to be examined based on a plurality of lights returning from the object to be examined to which a plurality of measurement lights is radiated, the imaging apparatus including: a scanning unit configured to scan the plurality of measurement lights; a detection unit configured to detect an arrangement of the plurality of measurement lights from the object to be examined; and an arrangement adjusting unit configured to adjust the arrangement with respect to a scanning direction of the scanning unit based on a detection result of the detection unit.

According to the present invention, an imaging apparatus can reduce a width of an arrangement of measurement lights in a scanning direction and obtain a tomogram with a high SN ratio.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are diagrams illustrating configurations of optical coherence tomography apparatuses according to first and second exemplary embodiments of the present invention.

FIGS. 2A and 2B are diagrams illustrating arrangements of optical fibers.

FIGS. 3A and 3B are diagrams each illustrating a location relationship of a light receiving unit and measurement lights.

FIGS. 4A, 4B, and 4C are diagrams illustrating a method of obtaining a relationship of the arrangement of the measurement lights and the line sensor L.

FIGS. 5A, 5B, 5C, and 5D are diagrams illustrating a method of obtaining an inclination of an arrangement of the measurement lights with respect to the line sensor L.

FIGS. 6A, 6B, and 6C are diagrams illustrating a method of obtaining location relationships of an inclination of the X-axis of a light scanning unit 6 with respect to a vertical direction (X-axis) of the line sensor L and the respective measurement lights.

FIG. 7 is a diagram illustrating a method of obtaining an inclination of the Y-axis of the light scanning unit with respect to the line sensor L.

FIGS. 8A, 8B, and 8C are diagrams illustrating a method of correcting a light scanning unit in the arrangement direction of the measurement lights in a tandem scanning operation.

FIG. 9 is a diagram illustrating a method of obtaining distances of measurement lights P1, P2, and P3.

FIG. 10 is a diagram illustrating a method of obtaining an arrangement of measurement lights.

FIG. 11 is a diagram illustrating a method of obtaining a rotation center location of an image rotator 2.

FIGS. 12A and 12B are diagrams illustrating a method of obtaining an inclination of the X-axis of the light scanning unit with respect to an arrangement of measurement lights.

FIGS. 13A and 13B are diagrams illustrating configurations of optical coherence tomography apparatuses according to third and fourth exemplary embodiments of the present invention.

FIG. 14 is a diagram illustrating a model eye.

FIGS. 15A and 15B are diagrams illustrating a method of obtaining a transverse strip of the model eye (detection model), an arrangement of measurement lights, and an inclination of a light scanning unit.

FIG. 16 is a diagram illustrating a method of obtaining an inclination of a scanning direction of the Y-axis of a light scanning unit with respect to a vertical strip.

### DESCRIPTION OF THE EMBODIMENTS

Various exemplary embodiments, features, and aspects of the invention will be described in detail below with reference to the drawings.

The present invention may be applied to any scanning type imaging apparatus (including an endoscope) such as an SLO, in addition to an optical coherence tomography apparatus. In addition, an object to be examined may be skin of a body to be examined in addition to an eye to be examined.

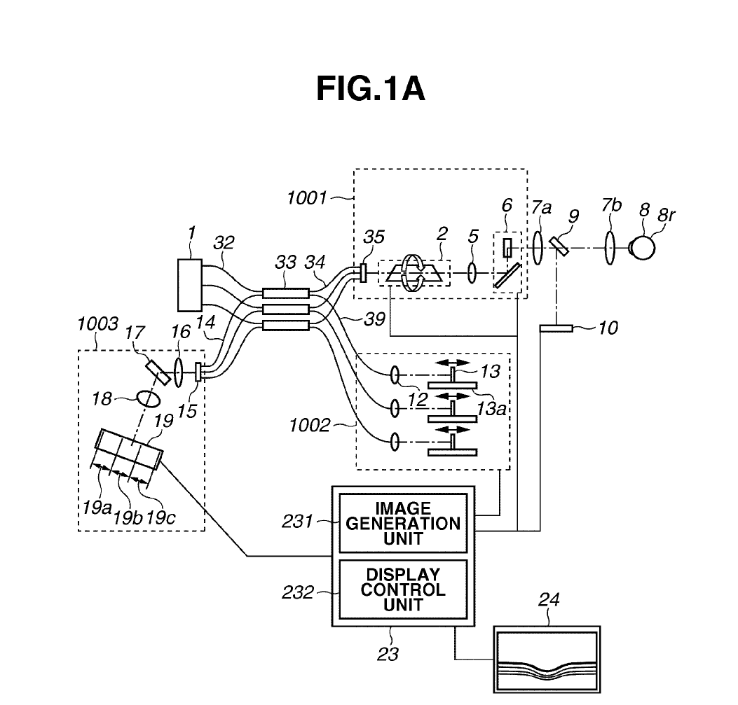

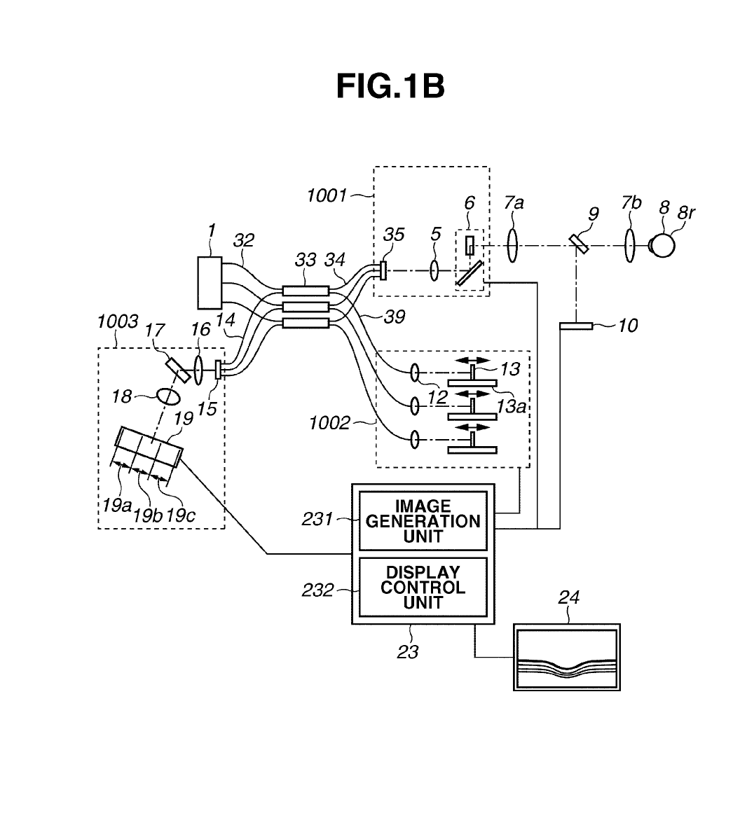

First, a first exemplary embodiment of the present invention will be described. FIG. 1A is a diagram illustrating a configuration of an optical coherence tomography apparatus (hereinafter, referred to as “OCT apparatus”) according to the present exemplary embodiment.

The OCT apparatus according to the present exemplary embodiment includes a light source 1, light branch units 33, a sample arm 1001, a reference arm 1002, a spectroscope 1003, a control unit 23, and a display unit 24. The light branch units 33 are connected to the light source 1, the spectroscope 1003, the sample arm 1001, and the reference arm 1002 via optical fibers 32, 34, 39, and 14. Further, the OCT apparatus according to the present exemplary embodiment has a configuration which is an exemplary application of an optical tomography apparatus.

The light source 1 is a light source that emits low-coherence light. Light (optical flux) emitted from the light source 1 propagates to the light branch units 33 via the optical fibers 32. Each of the light branch units 33 includes a fiber coupler and the like.

The reference arm 1002 functions as a reference optical system, and includes collimator lenses 12 and reference mirrors 13. The light (hereinafter, referred to as “reference light”) divided into the optical fibers 39 by the light branch units 33 enters the reference arm 1002, and the above-described configurations are provided on the optical paths.

Each of the reference mirrors 13 is moved along the optical axis direction by a driving force of a driving unit 13a. Accordingly, an optical path length of a reference light and an optical path length of a measurement light may coincide with each other even for eyes to be examined whose optical axis lengths are different.

In the present exemplary embodiment, the light source 1 has three light sources, the light branch units 33, the optical fibers 32, 34, 39, and the optical fibers 14. The numbers of each of the components are three corresponding to the three light sources.

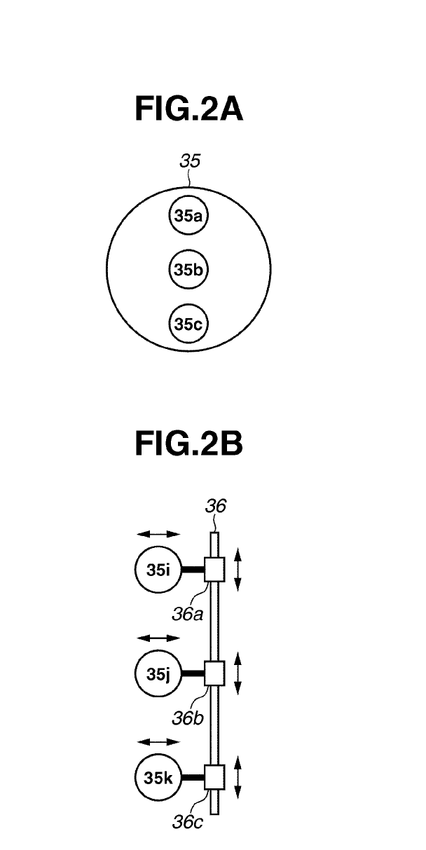

The sample arm 1001 functions as an imaging optical system, and includes a fiber connector 35, an image rotator 2, a collimator lens 5, and a light scanning unit 6. As illustrated in FIG. 2A, light (hereinafter, referred to as “measurement lights”) branched to the optical fibers 34 by the light branch unit 33 enters the fiber connector 35 in arrangements 35a, 35b, and 35c corresponding to the optical fibers 34, respectively.

The image rotator 2 for changing arrangement angles of the measurement lights is disposed on the optical path. The image rotator 2 is rotated on the optical path by a drive unit (not illustrated), to rotate the measurement lights and change the arrangement angles of the measurement lights.

The measurement lights enter the light scanning unit 6 via the collimator lens 5. The light scanning unit 6 includes a galvanometer mirror for scanning the measurement lights in the X-direction and the Y-direction disposed in tandem. The measurement light emitted from the light scanning unit 6 of the sample arm 1001 scans a fundus 8r of an eye 8 to be examined via a collimator lens 7a and an eyepiece lens 7b. Further, the measurement lights between the collimator lens 7a and the eyepiece lens 7b are radiated in parallel.

The spectroscope 1003 includes a fiber connector 15, a collimator lens 16, a light dispersing unit 17, an imaging lens 18, and an imaging unit 19. A combined light of the measurement light (returning light) and the reference light (reflected light) enters the spectroscope 1003 from the light branch unit 33, and the above-described configurations are provided on the optical paths. The light dispersing unit 17 functions to disperse light due to diffraction of light, and for example, a plurality of diffraction gratings (gratings, prisms, or the like) each having a size close to the wavelength of light is disposed at a regular interval.

The imaging unit 19 includes a line sensor (imaging sensor including photosensitive elements in a line form (CMOS sensor, CCD sensor, or the like)). The imaging unit 19 has detection regions 19a, 19b, and 19c for the light sources 1 on the line sensor, and detects signals of incident lights, respectively. Further, the imaging unit 19 generates signals corresponding to intensities for wavelengths, and outputs the corresponding signals to the control unit 23.

Herein, the combined light of returning light from the fundus 8r and reflected light from the reference mirrors 13 have a phase difference. The phase difference is generated due to a difference between an optical path length from the light branch units 33 to the fundus 8r and an optical path length from the light branch units 33 to the reference mirrors 13.

Further, since the phase difference varies according to the wavelength, interference fringes are generated in spectral intensity distributions appearing in the detection regions 19a to 19c. Brightness corresponding to a location of the reflective object can be obtained by obtaining a period of the intensity distribution (interference fringe).

The control unit 23 includes, for example, a central processing unit (CPU), a read only memory (ROM), a read access memory (RAM), and the like. As the CPU loads a program from the ROM to the RAM to execute the program, the control unit 23 controls the operations of the units of the OCT apparatus. More specifically, the controls unit 23 controls, for example, the image rotator 2, the light scanning unit 6, the driving units 13a, the imaging unit 19, and the like.

The control unit 23 implements the functions of an image generation unit 231 and a display control unit 232 by the CPU executing a program stored in the ROM.

The image generation unit 231 functions to analyze and calculate a signal detected by the imaging unit 19, and generate a tomogram of the fundus 8r, which is an object to be examined. Further, the display control unit 232 functions to display the tomogram of the fundus generated by the image generation unit 231 on the display unit 24.

The method of scanning a measurement light varies according to an object to be imaged, but for example, a scan image B can be acquired by scanning a measurement light in a primary direction. In a tandem scan, if the image rotator 2 makes an arrangement direction of the measurement lights coincide with a scanning direction of the light scanning unit 6, a scan image B having a high SN ratio can be obtained.

A mirror 9 disposed between the collimator lens 7a and the eyepiece lens 7b can be driven on a measurement optical path and at a location which does not interfere the measurement optical path. When a measurement lights scan the fundus 8r, the mirror 9 is driven to the location which does not interfere the measurement light.

A light receiving unit 10 is adapted to detect a measurement light, and includes a one-dimensional CCD line sensor, a two-dimensional CCD sensor, or the like. The light receiving unit 10 can detect a measurement light when the mirror 9 is disposed on a measurement optical path.

The control unit 23 also controls the mirror 9, the light receiving unit 10, and the like. The control unit 23 receives a signal detected by the light receiving unit 10 to calculate a location of a measurement light, and analyzes location relationships between the image rotator 2, the light scanning unit 6, and the measurement light.

When an arrangement state of the measurement lights is measured, the mirror 9 is disposed on the measurement optical path. The light radiated from the light source 1 passes on the sample arm 1001 and is radiated onto the light receiving unit 10 via the mirror 9 as a measurement light.

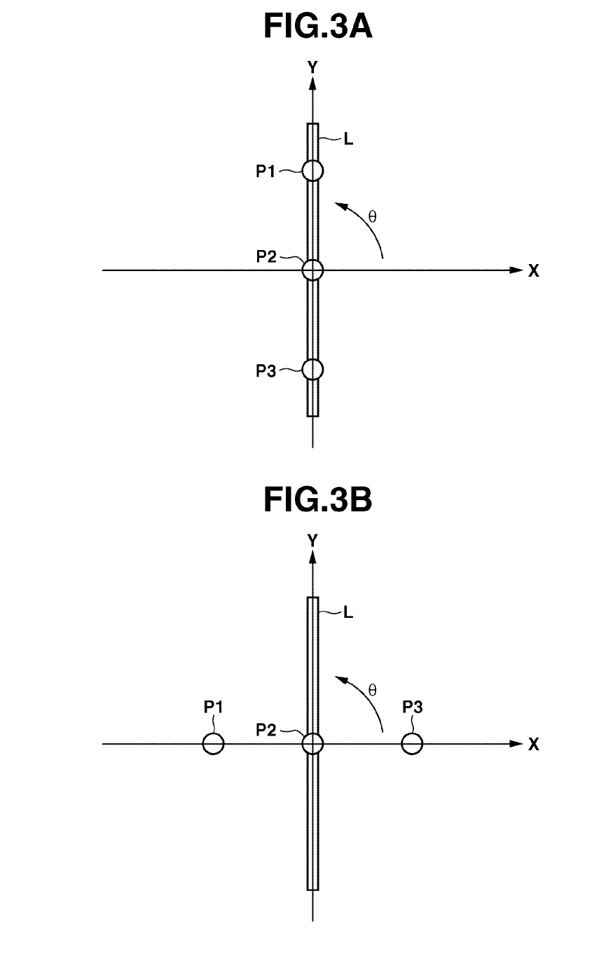

FIGS. 3A and 3B are diagrams illustrating a location relationship between the light receiving unit 10 and each of the measurement lights. Further, in the examples of FIGS. 3A and 3B, a one-dimensional CCD line sensor (hereinafter, simply referred to as “line sensor”) is used as the light receiving unit 10.

In FIGS. 3A and 3B, the linear part L is a line sensor, and P1, P2, and P3 disposed on the line denote measurement lights. Here, a lengthwise direction of the line sensor L is taken as the Y-axis of the line sensor L, and a vertical direction thereof is taken as the X-axis of the line sensor L.

When the OCT apparatus is started up, initial driving operations of the devices are completed, the mirror 9 is present on the measurement optical path, and measurement lights are radiated onto the light receiving unit 10, as illustrated in FIGS. 3A and 3B, the center of the line sensor L and the center of the arrangement of the measurement lights are designed to coincide with each other.

The location of the light scanning unit 6 is a location where the measurement lights are present on the line sensor L. For example, when the central measurement light P2 is radiated onto a minus coordinate side on the line sensor L in a design with no errors, the location of the light scanning unit 6 also becomes a location on the minus coordinate side. Further, the scale is the same as that of the line sensor L.

When the image rotator 2 is half rotated, the transmitting light is rotated, but an amount of rotation of light is set to be an amount of rotation of the image rotator 2 for convenience's sake of description. Further, the angle of the image rotator 2 when an arrangement of a measurement light is horizontal with respect to the line sensor L is set to be 0°, and the counterclockwise direction is set to be a plus direction.

First, the control unit 23 investigates a relationship of an arrangement of measurement lights with respect to the line sensor L. Herein, an inclination of a line connecting opposite ends of the arrangement, that is, the measurement light P1 and the measurement light P2 are set to an inclination of the arrangement of the measurement lights.

The inclination of the arrangement of the measurement lights is changed by the rotation of the image rotator 2. Thus, the control unit 23 obtains an inclination of the line connecting the measurement light P1 and the measurement light P3 based on a rotation center location, as a reference, where the image rotator 2 intends to make the arrangement of the measurement lights horizontal with respect to the line sensor L.

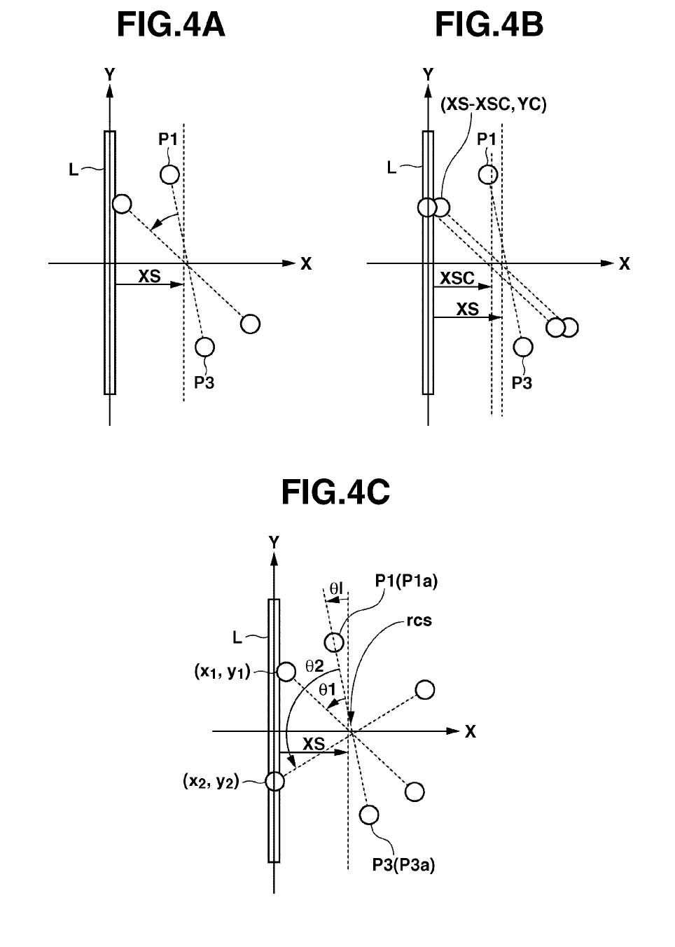

FIGS. 4A, 4B, and 4C are diagrams illustrating a method of obtaining a relationship of the arrangement of the measurement lights with respect to the line sensor L. In the present exemplary embodiment, the control unit 23 obtains an error of the arrangement of the measurement lights and the rotation center location of the image rotator 2 when the image rotator 2 makes the arrangement of the measurement lights horizontal with respect to the line sensor L.

As illustrated in FIG. 4A, the control unit 23 rotates the image rotator 2 to a location where the arrangement of the measurement lights becomes horizontal with respect to the line sensor L in design, and displaces the X-axis of the light scanning unit 6 in the X-axis direction of the line sensor L by one fourths of an interval from the line sensor L to the measurement light P1 and the measurement light P3. Here, if an amount of displacement of the X-axis of the light scanning unit 6 is represented by XS, the location of the light scanning unit 6 becomes (XS, 0) in the coordinate system of the line sensor L.

Herein, the amount of rotation of the image rotator 2 and the displacement of the light scanning unit 6 in the X-axis may be determined only by a design value. Thus, mounting errors of the fiber connector 35, the light scanning unit 6, and the image rotator 2, or an error in the rotating direction of the image rotator 2 when a starting point is determined, need not be considered.

A location convenient for calculation and explanation is selected as the displacement of the X-axis of the light scanning unit 6. When the image rotator 2 is rotated, the measurement light P1 and the measurement light P3 only need to pass through the line sensor L. However, an amount of displacement close to a half of the interval of the measurement light P1 and the measurement light P3 is not desirable in terms of precision.

In this state, the control unit 23 rotates the image rotator 2, and obtains two points where the measurement light P1 passes on the line sensor L. Here, point where a center of the measurement light P1 passes on the line sensor L is set to a point through which the measurement light P1 passes.

For example, when a diameter of the measurement light is 40 μm, one pixel of the line sensor L is 5 μm×5 μm, and a minimum amount of displacement of the light scanning unit 6 is 1 μm, a resolution of the light scanning unit 6 is higher than one pixel of the line sensor L. Thus, a point where an amount of light of the measurement light is maximal may be taken as a point where the measurement light passes on the line sensor L.

As illustrated in FIG. 4B, as one of methods of obtaining a center location of a measurement light when the measurement light passes on the line sensor L, the control unit 23 rotates the image rotator 2 until the line sensor L detects the measurement light.

If the line sensor L detects the measurement light, the control unit 23 stops the image rotator 2 at that time, and memorizes an angle of the image rotator 2. Subsequently, the control unit 23 displaces the X-axis of the light scanning unit 6 forward and rearward, and obtains a centroid position XSC of the X-axis from a total light amount of the pixels receiving the measurement light and locations of the pixels in the X-axis.

Thereafter, the control unit 23 displaces the X-axis of the light scanning unit 6 to the centroid position XSC of the X-axis, and obtains a centroid position YC of an amount of light of the pixels received by the line sensor L as a center location of the measurement light in the Y-axis. From above, the center locations XS-XSC and YC of the measurement light when the measurement light passes on the line sensor L are obtained.

After obtaining the passing points XS-XSC and YC of the measurement light on the line sensor L, the control unit 23 returns the X-axis of the light scanning unit 6 to a location of XS. Hereinbelow, a method of obtaining a center location of a measurement light when the measuring light passes on the line sensor L is the same.

Thereafter, as illustrated in FIG. 4C, based on angles θ1 and θ2 of the image rotator 2 when a center of the measurement light P1 passes on the line sensor L twice, and center locations (x1, y1) and (x2, y2) of the measurement light P1 when the measurement light P1 passes on the line sensor L, the control unit 23 obtains a rotation center location rcs of the image rotator 2 in the state where the X-axis of the light scanning unit 6 is displaced by XS, and a location of the measurement light P1 when the image rotator 2 makes the arrangement of the measurement light horizontal with respect to the line sensor L. Further, (x1, y1) is (XS-XSC, YC).

Likewise, based on angles of the image rotator 2 when a center of the measurement light P3 passes on the line sensor L twice, and center locations of the measurement light P3 when the measurement light P3 passes on the line sensor L, the control unit 23 obtains a rotation center location rcs of the image rotator 2 in the state where the X-axis of the light scanning unit 6 is displaced by XS, and a location of the measurement light P3 when the image rotator 2 makes the arrangement of the measurement light horizontal with respect to the line sensor L.

Herein, the arrangement of the measurement lights is set to be horizontal with respect to the line sensor L by using the rotation center location rcs of the image rotator 2, and the locations of the measurement lights P1 and P3 when the X-axis of the light scanning unit 6 is displaced by XS are set to P1a (P1ax, P1ay) and P3a (P3ax, P3ay).

An inclination of the line connecting P1a and P3a becomes an inclination θ1 of the arrangement of the measurement lights with respect to the line sensor L when the image rotator 2 makes the arrangement of the measurement lights horizontal with respect to the line sensor L.

That is, if an angle of the image rotator 2 when the image rotator 2 makes the arrangement of the measurement lights horizontal with respect to the line sensor L is set to 0, the inclination represents the same inclination as that of the image rotator 2 with respect to the line sensor L.

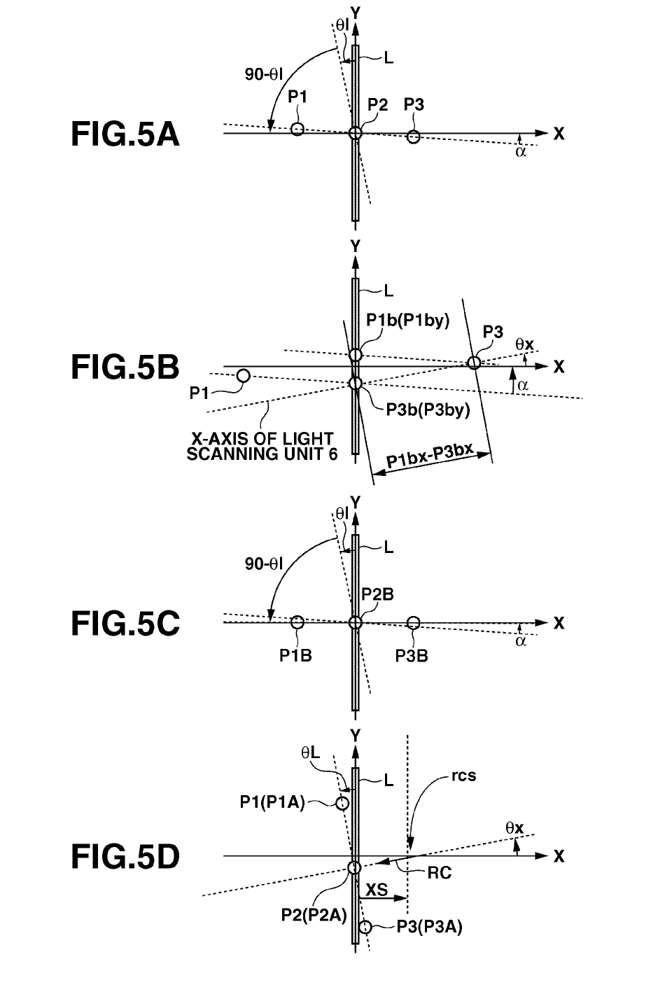

Thereafter, a method of obtaining an inclination of the X-axis of the light scanning unit 6 with respect to a vertical direction (X-axis) of the line sensor L, a location relationship between measurement lights, and an inclination of an arrangement of the measurement lights with respect to the line sensor L when the image rotator 2 makes the arrangement of the measurement lights horizontal with respect to the line sensor L, considering the location relationship, will be described with reference to FIGS. 5A, 5B, 5C, and 5D.

First, as illustrated in FIG. 5A, the control unit 23 rotates the image rotator 2, and makes the arrangement of the measurement lights P1 and P3 perpendicular with respect to the line sensor L. That is, the control unit 23 rotates the image rotator 2 by a degree obtained by subtracting θ1 from 90° to make the arrangement of the measurement lights P1 and P3 perpendicular with respect to the line sensor L.

Then, a drive residual angle α (a rotation angle of the image rotator 2 which lacks with respect to the vertical direction (X-axis) of the line sensor L) of the image rotator 2 becomes an inclination of the line sensor L in the vertical direction (X-axis) with respect to the arrangement of the measurement lights P1 and P3.

As illustrated in FIG. 5B, the control unit 23 displaces the X-axis of the light scanning unit 6 up to a location where the line sensor L is not present between the measurement lights P1 and P3. Herein, the control unit 23 displaces the X-axis of the light scanning unit 6 in a direction of the line sensor L.

The control unit 23 obtains an inclination θx of the X-axis of the light scanning unit 6 with respect to the vertical direction (X-axis) of the line sensor L from locations P3by and P1by on the line sensor L when the center of the measurement light P3 and the center of the measurement light P1 pass through the line sensor L and locations P3bx and P1bx of the X-axis of the light scanning unit 6 at that time. Further, since the drive residual angle α of the image rotator 2 is infinitesimal, θx is obtained by the following equation.

sin(θx)=((P1by−P3by)÷(P1bx−P3bx))−sin α

The control unit 23 scans the light scanning unit 6 to the X-axis, and memorizes a total received light amount of the pixels having received lights at locations of the X-axis of the light scanning unit 6 when obtaining a location where the center of the measurement light passes the line sensor L.

Thereafter, the control unit 23 obtains a centroid position of the total amount of the received lights, which is determined as a center location of the measurement lights of the light scanning unit 6 in the X-axis. Further, since the center location is on the line sensor L, a location of the X-axis of the line sensor L is 0. In addition, the centroid position of the amount of lights of the pixels which have been received by the line sensor L in the location is set to the center location of the measurement light in the Y-axis.

Location relationships between the measurement lights P1, P2, and P3 are obtained according to locations P1b (0, P1by), P2b (0, P2by), and P3b (0, P3by) on the coordinate of the line sensor L, the location P1bx, P2bx, and P3bx of the X-axis of the light scanning unit 6, and an inclination θx of the X-axis of the light scanning unit 6 with respect to the line sensor L when the center of the measurement light P1, the center of the measurement light P2, and the center of the measurement light P3 pass on the line sensor L.

However, the drive residual angle α of the image rotator 2 is infinitesimal. Thus, as illustrated in FIG. 5C, the locations P1B, P2B, and P3B of the measurement lights P1, P2, and P3, when it is assumed that the X-axis and the Y-axis of the light scanning unit 6 is located at 0 positions and the image rotator 2 is driven by the drive residual angle α (the rotation angle of the image rotator 2 is 90°−θ1), are obtained by the following equations.

P1B=P1b+(−P1bx×cos θx,P1bx×(sin α+sin θx))

P2B=P2b+(−P2bx×cos θx,P2bx×(sin α+sin θx))

P3B=P3b+(−P3bx×cos θx,P3bx×(sin α+sin θx))

FIG. 5D illustrates a method of obtaining a location relationship between the line sensor L and the measurement lights, and an inclination of the arrangement of the measurement lights when a rotation angle of the image rotator 2 is 0° and the X-axis and the Y-axis of the light scanning unit 6 are located at 0 positions. Herein, the rotation center location of the image rotator 2 is located at 0 positions of the X-axis and the Y-axis of the light scanning unit 6.

As described above, a rotation center location of the light scanning unit 6 is rcs when the X-axis thereof is displaced by XS in the X-axis direction of the line sensor L. Thus, the rotation center location RC of the image rotator 2 when the X-axis and the Y-axis of the light scanning unit 6 is located at 0 positions is obtained by the following equation.

RC=rcs−(XS×cos θx,XS×sin θx)

Thereafter, the control unit 23 returns the angle of the image rotator 2 to 0°. That is, the control unit 23 rotates the image rotator 2 from the location of FIG. 5C by θ1−90°. Then, locations P1A, P2A, and P3A of the measurement lights P1, P2, and P3 are obtained by the following equations.

$$R = ( \begin{matrix}sin θ 1 & cos θ 1 \\ - cos θ 1 & sin θ 1\end{matrix} ) \\ P 1 A = ( P 1 B - RC ) R + RC \\ P 2 A = ( P 2 B - RC ) R + RC \\ P 3 A = ( P 3 B - RC ) R + RC . \qquad [ Equation 1 ]$$

Here, the control unit 23 obtains a line passing through a vicinity of the locations P1A, P2A, and P3A by the method of least squares and the like. An inclination of the line sensor L with respect to the Y-axis is obtained as an inclination θL of the entire arrangement of the measurement lights with respect to the line sensor L when the arrangement of the measurement lights is made horizontal with respect to the line sensor L by rotating the image rotator 2.

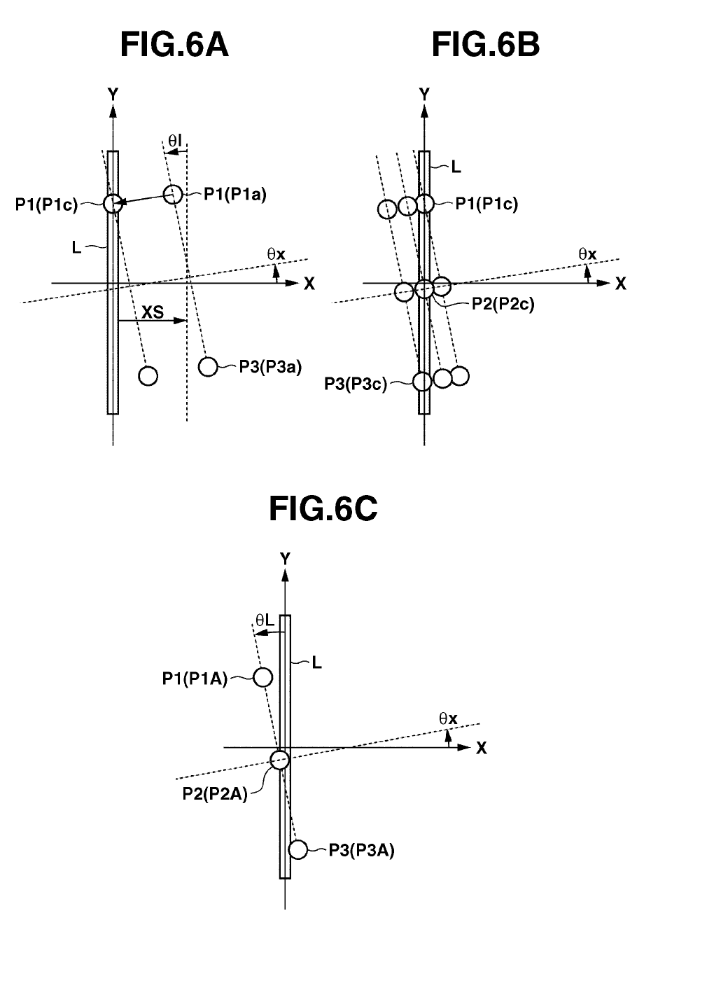

FIGS. 6A, 6B, and 6C are diagrams illustrating a method of obtaining location relationships of an inclination of the X-axis of the light scanning unit 6 with respect to the vertical direction (X-axis) of the line sensor L and the measurement lights, and illustrating a method different from FIGS. 5A to 5D.

As illustrated in FIG. 6A, the control unit 23 rotates the image rotator 2 to a location where the arrangement of the measurement lights is to be horizontal with respect to the line sensor L. Further, the control unit 23 displaces the X-axis of the light scanning unit 6 to a location displaced from the line sensor L in the X-axis direction by one fourth of an interval between the measurement light P1 and the measurement light P3, that is, XS.

Then, when the image rotator 2 is rotated and the light scanning unit 6 is driven, an amount of drive may be determined by a design value. Mounting errors of the fiber connector 35, the light scanning unit 6, and the image rotator 2, or an error in the rotation direction of the image rotator 2 when the starting point is determined, need not be considered. Thus, the location of the measurement light P1 and the location of the measurement light P3 are P1a and P3a, respectively, which have been obtained through the above-described processing.

The control unit 23 displaces the X-axis of the light scanning unit 6 in the direction of the line sensor L. An inclination of a line connecting the location P1a and the location P1c (0, p1cy) when the center of the measurement light P1 passes on the line sensor L is obtained as an inclination of the X-axis of the light scanning unit 6 with respect to the vertical direction (X-axis) of the line sensor L.

Further, the inclination of the X-axis of the light scanning unit 6 with respect to the vertical direction (X-axis) of the line sensor L may be obtained by obtaining the inclination of a line connecting the location P3a and the location P3c where the center of the measurement light P3 passes on the line sensor L.

It may be obtained by obtaining an average of an inclination of a line connecting the location P3a and the location P3c and an inclination of a line connecting the above-described location P1a and the location P1c. Further, in FIG. 6A, an inclination angle of the X-axis of the light scanning unit 6 with respect to the vertical direction (X-axis) of the line sensor L is denoted by ex as in FIG. 5B.

The location relationships of the measurement lights P1, P2, and P3 are obtained by locations P1c (0, P1cy), P2c (0, P2cy), and P3c (0, P3cy) on the line sensor L, and the locations P1cx, P2cx, and P3cx of the X-axis of the light scanning unit 6 when the centers of the measurement lights P1, P2, and P3 pass on the line sensor L, as illustrated in FIG. 6b.

The locations P1A, P2A, and P3A of the measurement lights P1, P2, and P3 when the X-axis of the light scanning unit 6 is located at 0 are obtained by the following equations.

P1A=P1c−(P1cx×cos θx,P1cx×sin θx)

P2A=P2c−(P2cx×cos θx,P2cx×sin θx)

P3A=P3c−(P3cx×cos θx,P3cx×sin θx)

As illustrated in FIG. 6C, the control unit 23 obtains a line passing through the locations P1A, P2A, and P3A by the method of least squares and the like. The inclination of the line with respect to the Y-axis of the line sensor L is obtained as an inclination θL of the entire arrangement of the measurement lights with respect to the line sensor L when the arrangement of the measurement lights is to be made horizontal with respect to the line sensor L.

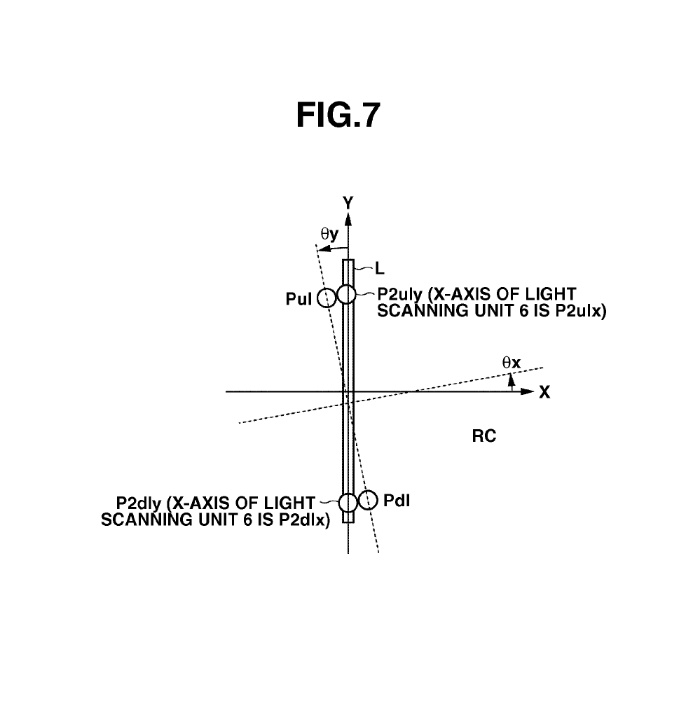

Thereafter, the control unit 23 obtains an inclination of the Y-axis of the light scanning unit 6 with respect to the line sensor L. FIG. 7 is a diagram illustrating a method of obtaining an inclination of the Y-axis of the light scanning unit 6 with respect to the line sensor

The control unit 23 locates the X-axis of the light scanning unit 6 to 0 position, and displaces the Y-axis of the light scanning unit 6 to a location where the measurement light P2 is situated in the vicinity of an upper part of the line sensor L. Further, the control unit 23 displaces the X-axis of the light scanning unit 6, and searches for a point where the center of the measurement light P2 passes on the line sensor L.

The control unit 23 obtains a location Pu1 of the measurement light P2 when the X-axis of the light scanning unit 6 is located at 0 position, from a location of the X-axis of the light scanning unit 6 and a location P2uly of the measurement light on the line sensor L when the center of the measurement light P2 passes on the line sensor L.

Here, Pu1 is obtained by the following equation, where θx represents a displacement of the X-axis of the light scanning unit 6 with respect to the line sensor L.

Pu1=(−P2ulx×cos θx,P2uly×sin θx)

Thereafter, the control unit 23 locates the X-axis of the light scanning unit 6 to 0 position, and displaces the Y-axis of the light scanning unit 6 to a location where the measurement light P2 is situated in the vicinity of a lower part of the line sensor L. Further, the control unit 23 displaces the X-axis of the light scanning unit 6, and searches for a point where the center of the measurement light P2 passes on the line sensor L.

The control unit 23 obtains a location Pd1 of the measurement light P2 when the X-axis of the light scanning unit 6 is located at 0 position, from the location P2dlx of the X-axis of the light scanning unit 6 and the location P2dly of the measurement light on the line sensor L when the center of the measurement light P2 passes on the line sensor L.

Herein, Pd1 is obtained by the following equation. Further, θx is a displacement of the X-axis of the light scanning unit 6 with respect to the line sensor L.

P2d=(−P2dlx×cos θx,P2dly×sin θx)

An inclination of a line connecting the location Pu1 and the location Pd1 is obtained as an inclination angle θy of the Y-axis of the light scanning unit 6 with respect to the line sensor L.

If an error in a verticality of the X-axis and the Y-axis of the light scanning unit 6 is infinitesimal and verticality with respect to the X-axis is not structurally present, ex is equal to ey and the present measurement may be omitted.

In the present exemplary embodiment, the light receiving unit 10 includes a one-dimensional CCD line sensor L, but may also include a two-dimensional CCD. Further, reference axes may be provided in the two-dimensional CCD to displace the scanning unit 6, measure angle errors of the axes, and obtain an amount of corrections of the axes.

When the two-dimensional CCD is used, even if a mechanism for changing an arrangement of the measurement lights such as the image rotator 2 is not driven, an inclination of the axis of the light scanning unit 6 with respect to the inclination of the arrangement of the measurement lights can be obtained. In order to obtain the center locations of the measurement lights by using the two-dimensional CCD, a centroid position of an amount of lights of pixels of the CCD having received the measurement lights may be obtained.

As described above, in the present exemplary embodiment, a displacement of the rotation center location of the image rotator 2, a location of the measurement lights with respect to the location of the image rotator 2, an angle of the arrangement of the measurement lights obtained from the location, and a location relationship of the angles of the axes of the light scanning unit 6 may be obtained with reference to the location of the light receiving unit 10 for receiving the measurement lights.

When the obtained angle and location are different from design values, the angle of the arrangement of the measurement lights may be corrected by the image rotator 2. In addition, the rotation center location of the image rotator 2 and the center location of the arrangement of the measurement lights can be corrected by the light scanning unit 6. Further, the measurement lights may become close to the locations of the design values.

The measurement location is determined with reference to the coordinate of the light receiving unit 10. A relationship of a location where the mirror 9 is not present on the measurement optical paths and the measurement lights are radiated onto the eyepiece lens 7b, and a location where the mirror 9 is present on the measurement optical path and the measurement lights are radiated to the light receiving unit 10, is defined. Further, the coordinate system of the light receiving unit 10 is adjusted to the coordinate system of the eyepiece lens 7b. Accordingly, the measurement location may be calibrated to a location on the coordinate of the fundus 8r.

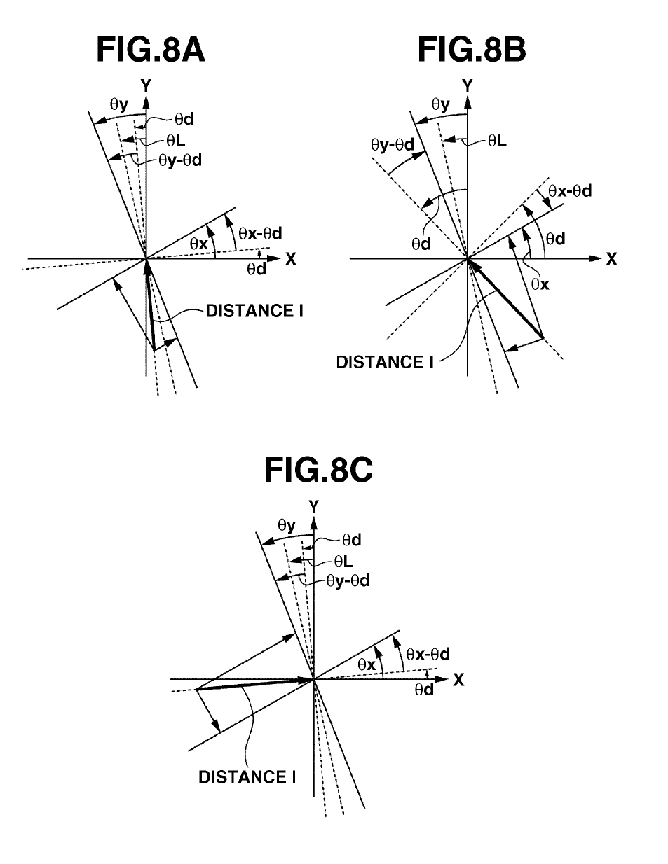

FIGS. 8A, 8B, and 8C are diagrams illustrating a method of correcting the light scanning unit 6 in the arrangement direction of measurement lights in a tandem scanning operation.

During a tandem scanning operation, it is required to reduce a width of the measurement lights with respect to the scanning direction by scanning the light scanning unit 6 in an arrangement direction of the measurement lights.

For example, as illustrated in FIG. 8A, if a tandem scanning operation is to be performed vertically, the control unit 23 displaces the image rotator 2 by −θL. At that time, when a drive residual angle θd with respect to −θL is generated due to the drive resolution of the image rotator 2, the arrangement of the measurement lights itself is inclined by θd with respect to the line sensor L.

A state where a drive residual angle θd is generated is a state where the image rotator 2 is intended to be displaced by −θL, but is actually displaced only by −θL-θd. Thus, if the light scanning unit 6 scans the measurement lights so that the measurement lights is made horizontal to θd, a tandem scanning operation with a higher SN ratio can be performed.

That is, θy-θd is an angle of the Y-axis of the light scanning unit 6 with respect to the arrangement direction of the measurement lights. Further, θx-θd is an angle of the X-axis of the light scanning unit 6 with respect to the vertical direction of the arrangement direction of the measurement lights.

Thus, as illustrated in FIG. 8A, when a traveling direction of the measurement lights is a plus side of the Y-axis, the light scanning unit 6 may be driven by a value obtained by multiplying the distances from the X-axis and the Y-axis of the light scanning unit 6 by the following correction coefficient, to move the measurement lights by a distance l in addition to the angle of the arrangement direction θd.

When the progress direction of the measurement lights is a minus side of the Y-axis, a value for driving the light scanning unit 6 takes a minus value. Further, when θy-θd is a minus value, the correction coefficient of the X-axis is a value obtained by multiplying the following calibration coefficient of the X-axis by −1.

$$Y \text{-} axis coefficient \text{:} \frac{\sqrt{{( tan ( θ y - θ d ) \times tan ( θ x - θ d ) )}^{3} + {( tan ( θ y - θ d ) )}^{2}}}{1 + tan θ ( θ y - θ d ) \times tan ( θ x \times θ d )} \\ X \text{-} axis coefficient \text{:} \frac{\sqrt{{( 1 + tan ( θ y - θ d ) )}^{2}}}{1 + tan θ ( θ y - θ d ) \times tan ( θ x \times θ d )} \qquad [ Equation 2 ]$$

If an amount of scans of the axes of the light scanning unit 6 is corrected, a width of the measurement lights with respect to the scanning direction of the light scanning unit 6 can be reduced. θd is an inclination of the arrangement of the measurement lights with respect to the line sensor L. Thus, for example, as illustrated in FIG. 8B, when a tandem scanning operation is performed at an angle inclined by an angle θT with respect to the line sensor L, the control unit 23 displaces the image rotator 2 by θT-θL.

If the drive residual angle at that time is θD, and θd is an inclination of the measurement lights with respect to the line sensor L, they can be expressed by the following equation. The above equation can be applied to an amount of correction of the axis of the light scanning unit 6 for moving the measurement lights by 1.

θd=θT−θL−θD

Further, in the above correction equation, when θT is not present within ±45°, θd is calculated with reference to the vertical direction with respect to the line sensor L. Further, correction coefficients may be obtained by replacing the X-axis and the Y-axis of the calibration equation.

As illustrated in FIG. 8C, when the moving direction of the measurement lights is a plus side of the X-axis, the light scanning unit 6 may be driven by a value obtained by multiplying the distances of the driving shaft from the X-axis and the Y-axis by the following correction coefficients, to move the measurement lights by the distance l according to an angle of the arrangement direction ed. If the moving direction is a minus side of the X-axis, the distance takes a value of the minus side.

When θx-θd is a plus value, a value obtained by multiplying the calibration coefficient of the Y-axis by −1 is the correction coefficient of the Y-axis.

$$Y \text{-} axis coefficient \text{:} \frac{\sqrt{{( tan ( θ y - θ d ) \times tan ( θ x - θ d ) )}^{2} + {( tan ( θ x - θ d ) )}^{2}}}{1 + tan θ ( θ y - θ d ) \times tan ( θ x \times θ d )} \\ X \text{-} axis coefficient \text{:} \frac{\sqrt{{( tan ( θ y - θ d ) \times tan ( θ x - θ d ) )}^{2} + {( tan ( θ x - θ d ) )}^{2}}}{1 + tan θ ( θ y - θ d ) \times tan ( θ x \times θ d )} \qquad [ Equation 3 ]$$

In the present exemplary embodiment, after an error angle of the arrangement of the measurement lights and the inclinations of the axes of the light scanning unit 6 is measured while taking the line sensor L as a reference of the Y-axis, amounts of corrections of driven objects are obtained. However, after an error of the angle with respect to the reference is measured while taking any one of the X-axis and Y-axis of the light scanning unit 6 and the angle of the arrangement of the measurement lights with respect to the reference location of the image rotator 2 as a reference, a correction amount of each of the drive units may be obtained.

As described above, the location relationships of locations of the measurement lights, an angle of the arrangement of the measurement lights, and a scanning angle of the light scanning unit 6 are obtained based on a location and light amount of the measurement light when the light receiving unit 10 detects the measurement light, a location of the image rotator 2, and a location of the light scanning unit 6.

Since the scanning direction of the scanning unit 6 can be matched with the arrangement of the measurement lights from above location relationships, an adjustment needs not be performed precisely during an assembly process. Further, even when a displacement is generated due to a temporal change or an impact, the scanning direction of the light scanning unit with respect to the displacement of the measurement lights can be corrected. Thus, a width of the measurement light with respect to the scanning direction produced by the measurement light can be reduced.

Further, since the location relationships of the measurement lights can be measured, it can be seen whether the measurement lights are displaced from the design values of the measurement lights. Thus, the data arrays can be averaged at the same measurement sites of the measured object where each measurement light radiates by displacing the image by the displacement. Accordingly, an optical tomogram with a high SN ratio can be obtained in a tandem scanning operation.

Hereinafter, a second exemplary embodiment of the present invention will be described. FIG. 1B is a diagram illustrating a configuration of an OCT apparatus according to the second exemplary embodiment of the present invention. In the present exemplary embodiment, an imaging apparatus using optical coherence tomography of a Fourier domain type will be exemplified as the OCT apparatus according to the present exemplary embodiment.

The difference from the first exemplary embodiment lies in that the image rotator 2 for changing an angle of measurement lights is not present between the fiber connector 35 and the light scanning unit 6. Since, in many cases, a horizontal tomogram of the eye is taken in the clinical field, the arrangement of the measurement lights in the fiber connector 35 is fixed to the arrangement 35a, 35b, and 35c of FIG. 2A with respect to the light sources of the optical fibers 34 horizontally.

In the present exemplary embodiment, the mirror 9 is disposed on the measurement optical path to measure an arrangement state of measurement lights. The light radiated from the light source 1 passes through the sample arm 1001, and is radiated to the light receiving unit 10 as a measurement light via the mirror 9.

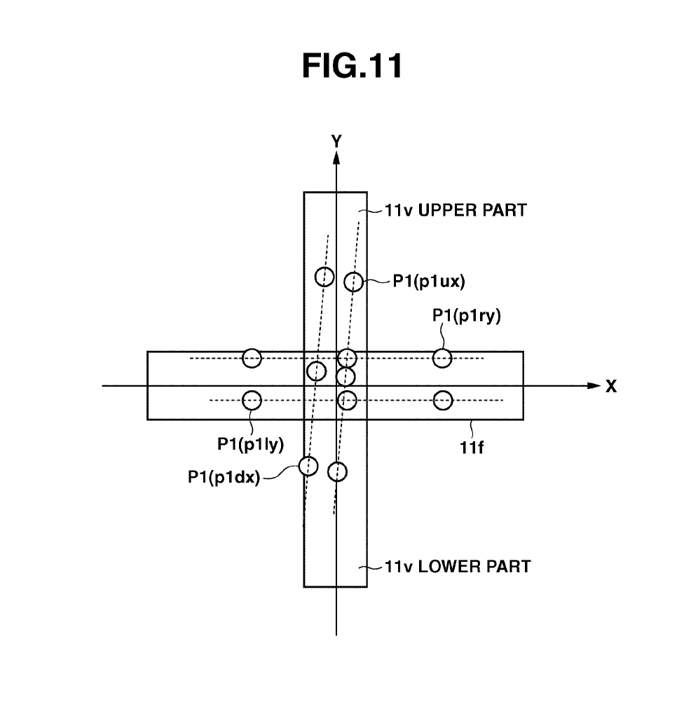

FIG. 11 is a diagram illustrating the light receiving unit 10 and locations of the measurement lights. In the present exemplary embodiment, an example in which the light receiving unit 10 includes a one-dimensional line sensor will be described.

In FIG. 11, the linear part is a line sensor L, and lights P1, P2, and P3 are measurement lights. Herein, the line sensor L is treated as the Y reference axis of the coordinate of the line sensor. When the apparatus is started up, initial driving operations of the devices are completed, the mirror 9 is present on a measurement optical path, and measurement lights are radiated to the light receiving unit 10, as illustrated in FIG. 11, the center of the line sensor L and the center of an arrangement of the measurement lights coincide with each other in design.

The location of the light scanning unit 6 is a location where the measurement lights are present on the line sensor L, that is, a location of the light scanning unit 6 when the measurement lights in design which do not contain errors radiate a minus coordinate side on the line sensor L is a minus location. The scale is the same as that of the line sensor L.

In the present exemplary embodiment, the arrangement of the measurement lights cannot be changed. Thus, the scanning direction of the light scanning unit 6 is matched with the inclination of the arrangement of the measurement lights by obtaining the arrangement of the measurement lights P1, P2, and P3 and the inclination angle θx of the X-axis of the light scanning unit 6, and correcting the light scanning unit 6 to the inclination of the arrangement of the measurement lights.

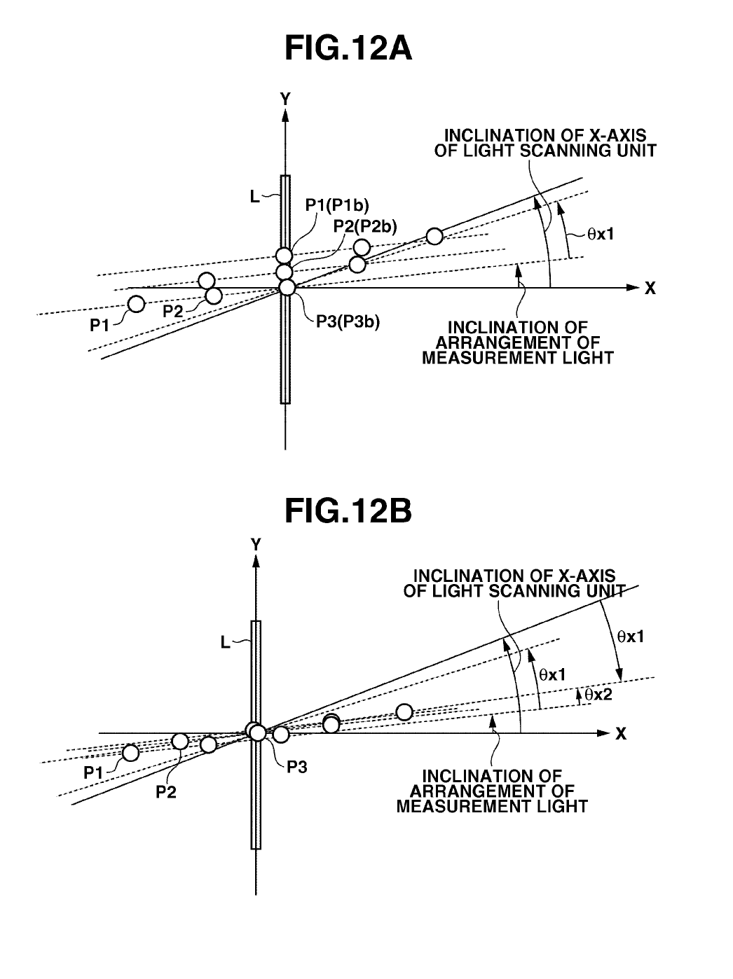

FIGS. 12A and 12B are diagrams illustrating a method of obtaining an inclination of the X-axis of the light scanning unit with respect to the arrangement of measurement lights. The control unit 23 drives the X-axis of the light scanning unit 6, and displaces the X-axis of the light scanning unit 6 up to a location where a line sensor L is not present between the measurement lights P1, P2, and P3.

As illustrated in FIG. 12A, the control unit 23 drives the X-axis of the light scanning unit 6 in the direction of the line sensor L. Further, the control unit 23 obtains locations P1b, P2b, and P3b on the line sensor and locations P1bx, P2bx, and P3bx of the X-axis of the light scanning unit 6 when a center of the measurement lights P1, P2, and P3 passes on the line sensor L.

When obtaining a location where a center of the measurement light passes on the line sensor L by performing a scanning operation to the X-axis by the light scanning unit 6, a total amount of received lights of the pixels which have been received at the locations of the X-axis of the light scanning unit 6 through the scanning operation is memorized.

A centroid position of the amount of received lights may be obtained and may be set as a center location (a location of the X-axis on the coordinate of the line sensor is 0 because the center location is on the line sensor L) of the measurement light in the X-axis. Further, a centroid position of the amount of lights of the pixels which have been received by the line sensor L may be a center location of the measurement lights in the Y-axis.

Here, an angle θx1 is obtained as an inclination of the X-axis of the light scanning unit 6 with respect to the arrangement of the measurement lights P1 and P3 by satisfying P1b=(0, P1by); P2b=(0, P2by); P3b=(0, P3by) and employing the spaced P1 and P3 as the measurement lights.

tan(0x 1)=(P3by−P1by)÷(P3bx−P1bx)

However, when θxq is a large value around 10° due to the inclination of the light scanning unit 6, a cos− error also increases. Thus, for example, when a distance between the measurement light P1 and the measurement light P3 is 2 mm, if it is corrected by an angle of θx1, a width of approximately 5 μm with respect to the scanning axis where the center of the measurement lights is corrected, is present.

Although depending on a precision needed, if the obtained angleθx1 is large, a sufficient precision can be obtained by obtaining an inclination θx2 in the scanning direction of the light scanning unit 6 with respect to the measurement lights P1 and P3 again in a state where the light scanning unit 6 is corrected by the angle θx2, that is, in a state where the scanning direction of the light scanning unit 6 is inclined by −θx1 to be close to the arrangement of the measurement lights as illustrated in FIG. 12B.

Since the scanning direction is around the X-axis and a difference in an amount of corrections due to an inclination of the Y-axis is small, the inclination of the Y-axis with respect to the arrangement of the measurement lights used for calculation of the amount of corrections of the light scanning unit 6 for correction may be 0°. However, since θx1 is practical, the inclination of the Y-axis is calculated as θx1.

The following correction coefficients are correction coefficients for the drive axes of the light scanning unit 6 in the X-axis and the Y-axis when the measurement lights moves according to an angle of the arrangement direction θx1. In this case, a value obtained by multiplying a distance by the following correction coefficients may be amounts of drives of the axes of the light scanning unit 6 in the X-axis and the Y-axis when the measurement lights are displaced by a distance l.

When the moving direction of the measurement light is a plus side of the X-axis, the distance takes a plus value. When the moving direction thereof is a minus side of the X-axis, the distance takes a minus value. Further, when θx1 is a plus value, the correction coefficient of the Y-axis is a value obtained by multiplying the coefficient of the Y-axis by −1.

$$Correction coefficient of X \text{-} axis \\ \frac{1}{\sqrt{1 + {( tan ( θ \times 1 ) )}^{2}}} \\ Correction coefficient of Y \text{-} axis \\ \frac{\sqrt{{( tan ( θ \times 1 ) )}^{4} + {( tan ( θ \times 1 ) )}^{2}}}{1 + {( tan ( θ \times 1 ) )}^{2}} \qquad [ Equation 4 ]$$

That is, the control unit 23 drives the X-axis of the light scanning unit 6 again in this state, and displaces the X-axis of the light scanning unit 6 to a location where a line sensor L is not present between the measurement lights P1, P2, and P3.

As illustrated in FIG. 12B, the control unit 23 drives the light scanning unit 6 in the X-direction in a state where the light scanning unit 6 is corrected to an angle of θx1 in the direction of the line sensor L. Further, the control unit 23 obtains an angle θx1 of the scanning axis corrected with the angle θx1, from locations P1b, P2b, and P3b on the line sensor L and locations P1bx, p2bx, and P3bx of the X-axis of the light scanning unit 6 when the center of the measurement lights P1, P2, and P3 passes on the line sensor L.

Like the case of obtaining the angle θx1, when P1b=(0, P1by); P2b=(0, P2by); P3b=(0, P3by) is satisfied, the angle θx2 is obtained by the following equation.

tan(θ×2)=(P3by−P1by)÷(P3bx−P1bx)×{square root over (1+(tan(0x1))²)}) [Equation 5]

The locations P1B, P2B, and P3B of the measurement lights P1, P2, and P3 when the location of the light scanning unit 6 is 0 are obtained by the following equation.

$$P 1 B = P 1 b + ( - P 1 bx \times \sqrt{1 + {( tan ( θ \times 1 ) )}^{2}} \times csc ( θ \times 2 ) , P 1 bx \times \sqrt{1 + {( tan ( θ \times 1 ) )}^{2}} \times sin ( θ \times 2 ) \\ P 2 B = P 2 b + ( - P 2 bx \times \sqrt{1 + {( tan ( θ \times 1 ) )}^{2}} \times csc ( θ \times 2 ) , P 2 bx \times \sqrt{1 + {( tan ( θ \times 1 ) )}^{2}} \times sin ( θ \times 2 ) \\ P 3 b = P 3 b + ( - P 3 bx \times \sqrt{1 + {( tan ( θ \times 1 ) )}^{2}} \times csc ( θ \times 2 ) , P 3 bx \times \sqrt{1 + {( tan ( θ \times 1 ) )}^{2}} \times sin ( θ \times 2 ) \qquad [ Equation 6 ]$$

If a line passing through vicinities of the locations P1B, P2B, and P3B is obtained by the least squares method, an angle θx3 of the inclination of the line is obtained. Accordingly, the angle θx of the inclination of the X-axis of the light scanning unit 6 with respect to the arrangement of the measurement lights is obtained by the following equation.

θx=θx1+θx2−θx3

The light receiving unit 10 includes a one-dimensional line sensor L in the present exemplary embodiment, but may include a two-dimensional CCD. In this case, an angle error of the X-axis may be measured by providing the two-dimensional CCD with a reference axis, and an amount of corrections of the drive axes may be obtained. In this case, in order to obtain the center locations of the measurement lights, a centroid position of the amount of lights of the pixels of the two-dimensional CCD which have been received from the obtained measurement lights may be obtained.

Further, when the light receiving unit 10 includes a two-dimensional CCD, the axes of the light scanning unit 6 are driven independently, and an inclination of the X-axis and an inclination of the Y-axis of the light scanning unit 6 with respect to the light receiving unit 10 are also obtained according to the location of the light scanning unit and the locations of the measurement lights measured by the light receiving unit 10.

As described above, a location of the arrangement of the measurement lights with respect to the scanning direction of the light scanning unit 6 and an angle of the arrangement of the measurement lights obtained from the location can be obtained by taking the location of the light receiving unit 10 for receiving the measurement lights as a reference.

When the obtained location is different from the design value, a center location of the arrangement of the measurement lights can be corrected by the light scanning unit 6. Further, the measurement light can be made closer to a location of a design value.

Although the coordinate of the light receiving unit 10 is taken as a reference for the above-described measurement positions, a relationship of a location where the mirror 9 is not present on the measurement optical path and the measurement lights are radiated into the eyepiece lens 7b, and a location where the mirror 9 is present on the measurement optical path and the measurement lights are radiated to the light receiving unit 10 is defined. Accordingly, the coordinate system of the location of the light receiving unit 10 is matched with the coordinate system of the eyepiece lens 7b, and the location of the light receiving unit 10 can be corrected with the coordinate on the fundus 8r.

In a tandem scanning operation, it is necessary to reduce a width of the measurement lights with respect to the scanning direction produced by the measurement lights with respect to the scanning direction of a light scanning system. To this end, it is possible to reduce a width of the measurement lights with respect to the scanning direction by matching the scanning direction with the light scanning system with respect to the inclination of the arrangement of the measurement lights.

That is, the scanning direction of the'light scanning system 6 can be matched with respect to the arrangement of the measurement lights by using the X-axis and the angle θx of the inclination of the light scanning unit 6 with respect to the arrangement of the obtained measurement lights and calibrating the light scanning system 6 using the following equation. Thus, a width of the measurement lights with respect to the scanning direction produced by the measurement lights with respect to the light scanning system.

$$Correction coefficient of X \text{-} axis \\ \frac{1}{\sqrt{1 + {( tan ( θ \times ) )}^{2}}} \\ Correction coefficient of Y \text{-} axis \\ \frac{\sqrt{{( tan ( θ \times ) )}^{4} + {( tan ( θ \times ) )}^{2}}}{1 + {( tan ( θ \times ) )}^{2}} \qquad [ Equation 7 ]$$

The correction coefficients are correction coefficients for the drive axes of the light scanning unit 6 in the X-axis and the Y-axis when the measurement lights move according to an angle of the arrangement direction θx. In this case, values obtained by multiplying a distance by the above correction coefficients may be amounts of drives of the axes of the light scanning unit 6 in the X-axis and the Y-axis when the measurement lights are displaced by a distance l.

When the moving direction of the measurement lights is a plus side of the X-axis, the distance takes a plus value. When the moving direction thereof is a minus side of the X-axis, the distance takes a minus value. Further, when θx is a plus value, the correction value of the Y-axis is a value obtained by multiplying the coefficient of the Y-axis by −1.

As described above, the location relationships of locations of the measurement lights, an angle of the arrangement of the measurement lights, and a scanning angle of the light scanning unit 6 are obtained based on a location and light amount of the measurement lights when the light receiving unit 10 detects the measurement lights and a location of the light scanning unit 6.

Since the scanning direction of the scanning unit 6 can be matched with the arrangement of the measurement lights from the location relationships, an adjustment need not be performed precisely during an assembly process. Further, even when a displacement is generated due to a temporal change or an impact, the scanning direction of the light scanning unit 6 with respect to the arrangement of the measurement lights can be corrected. Thus, a width of the measurement lights with respect to the scanning direction produced by the measurement lights can be reduced.

Since the location relationships of the measurement lights can be measured, it can be seen whether the measurement lights are displaced from the design values of the measurement lights. Thus, the data arrays at measurement sites where the measurement objects of the light sources are the same can be averaged by displacing an image by the displacement. Accordingly, an optical tomogram with a high SN ratio can be obtained in a tandem scanning operation.

In the present exemplary embodiment, errors of the inclinations of the axes of the light scanning unit 6 with respect to the arrangement of the measurement lights are measured, and amounts of corrections of drive objects are obtained while taking the line sensor L as a reference of the Y-axis. However, as another exemplary embodiment, while taking any one of the X-axis and the Y-axis of the light scanning unit or the angle of the arrangement of the measurement lights as a reference, an error in angle and location with respect to the corresponding reference may be measured, and the amounts of corrections of the drive units may be obtained.

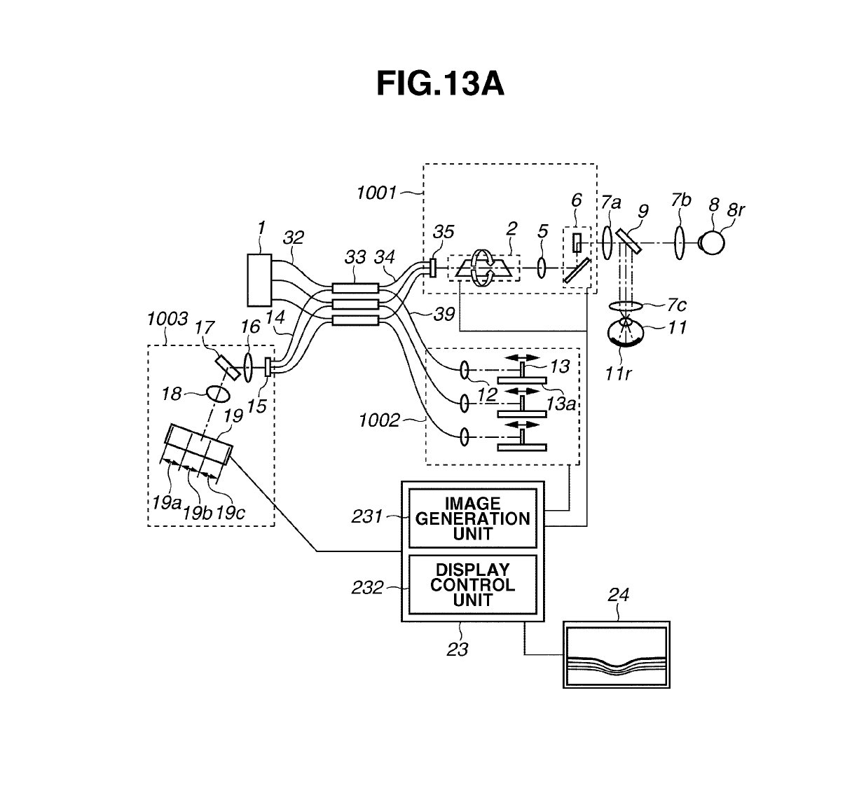

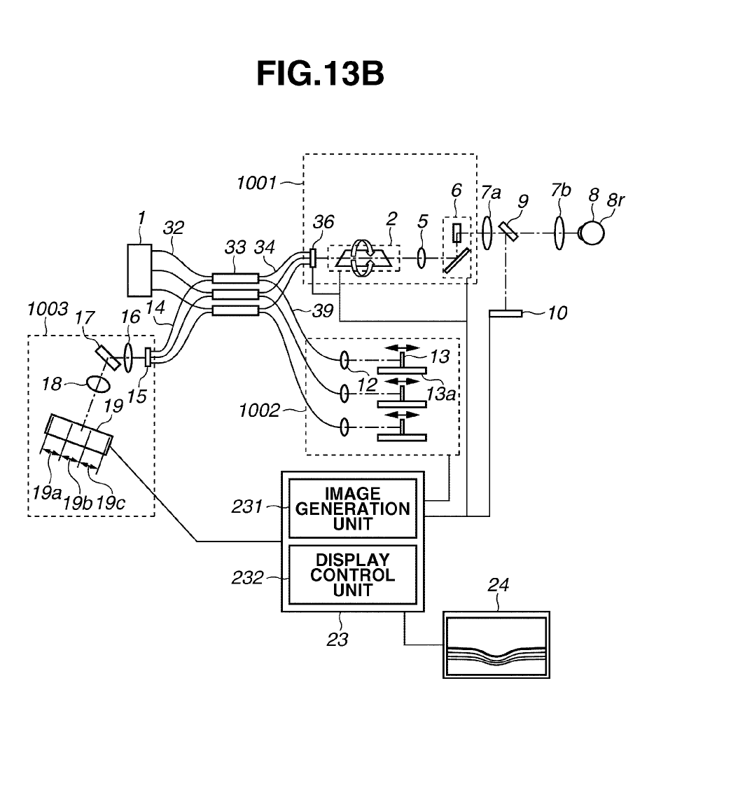

Hereinafter, a third exemplary embodiment of the present invention will be described. FIGS. 13A and 13B are diagrams illustrating a configuration of an optical coherence tomography (OCT) apparatus according to the third exemplary embodiment of the present invention. In the present exemplary embodiment, an imaging apparatus using a Fourier domain type optical coherence tomography will be exemplified. The difference between the first exemplary embodiment and the third exemplary embodiment lies in that a model eye 11 (detection model) is provided at a site optically equivalent to the fundus instead of the light receiving unit 10.

In the model eye 11, as the mirror 9 is disposed on the measurement optical path, measurement lights are radiated to the objective lens 7c and a tomogram of the model eye bottom 11r can be measured.

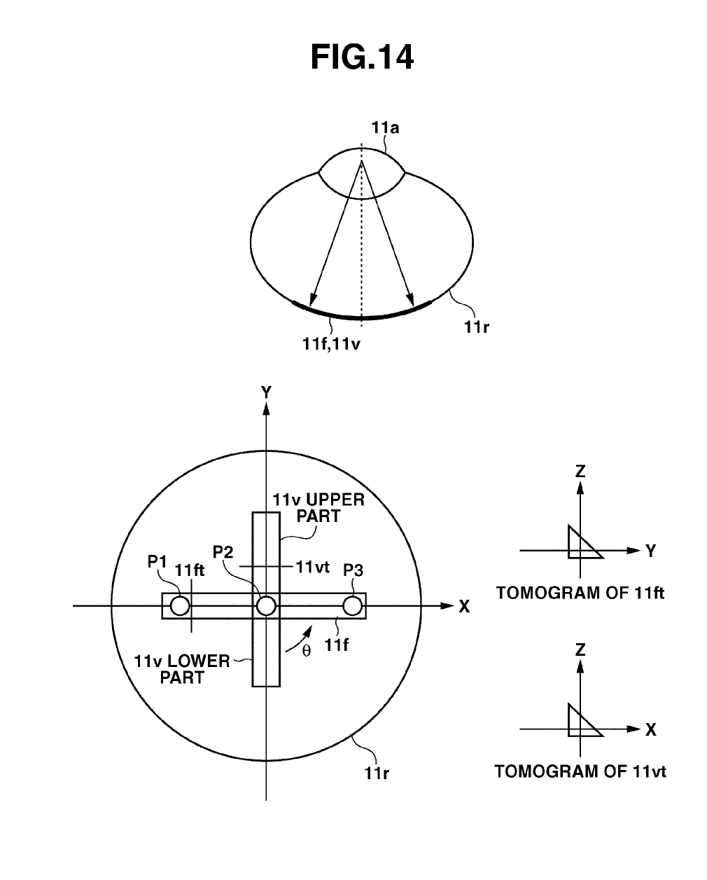

The model eye 11 has strips with different tomography thicknesses detected according to the locations to which the measurement lights are radiated as illustrated in FIG. 14. Here, the arrangement of the measurement lights in the fiber connector 35 is fixed as illustrated in 35a, 35b, and 35c of FIG. 2A, with respect to the light sources of the optical fibers 34 horizontally.

In the third exemplary embodiment, in order to measure the arrangement state of the measurement lights, the mirror 9 is disposed on the measurement optical path. The light radiated from the light source 1 passes through the sample arm 1001, and is radiated to the model eye 11 as a measurement light via the mirror 9. The radiated measurement light is combined with the reference light as a returning light to enter the spectroscope 1003. As a result, it is possible to acquire a tomogram.

FIG. 14 is a diagram illustrating the model eye 11. As illustrated in FIG. 14, the model eye 11 imitates an eye of a human body and has a lens 11a instead of a crystalline lens.

A measurement light forms an image at the model eye bottom 11r positioned at a site optically equivalent to the fundus 8r via the lens 11a and directs to the spectroscope 1003 as a returning light. The light scanning unit 6 scans the model eye bottom 11r while taking the center of the lens 11a as a pivot.

The model eye bottom 11r has a spherical surface about the pivot within a scanning range. Accordingly, a scanning angle and a coordinate of the model eye bottom 11r form a proportional relation, and a displacement of a location due to an error of the incident location of the measurement light becomes small.

As illustrated in FIG. 14, a strip where a tomogram is detected is present at the center of the model eye bottom 11r. A thickness of the tomogram varies with respect to the vertical direction of the strip. Further, a location in the vertical direction of the strip can be determined according to the thickness of the tomogram.

A detection unit 11 has two crossed strips 11v and 11f perpendicular to each other. The center of the transversely extending strip 11f crosses the vertically extending strip 11v. The central overlapping portion represents that the thickness of the tomogram varies vertically.

The vertical strip 11v on the coordinate is a reference of the Y-axis. The thicknesses of the measured tomogram are different as a location where the measurement light is radiated on a side vertical to the strip of the tomogram, that is, in the X-axis. Thus, the irradiated location in the X-direction can be specifically obtained according to the thickness.

In the transverse strip 11f, a thickness of the tomogram varies according to a location where the measurement light is radiated with respect to the Y-direction. The location in the X-direction can be specifically obtained with respect to the thickness. Thus, in the transverse strip 11f in the direction of thickness, the location Py in the Y-direction with respect to the thickness t is obtained as follows.

Py=fy(t)

In the vertical strip 11v, the location Px in the X-direction with respect to the thickness t is obtained as follows.

Px=fx(t)

In the present exemplary embodiment, the model eye has a strip-like shape. This allows a large difference in thickness of the tomograms measured according to a small change in the location of the measurement light, increasing a resolution of the location.

In the present exemplary embodiment, the model eye bottom 11r is a spherical surface about a pivot, but may have a planar shape or a spherical shape such as an eyeball while the pivot is located at the crystalline lens. In this case, a location of the model eye bottom 11r with respect to the scanning angle may be corrected.

In FIG. 14, P1, P2, and P3 are measurement lights. When the apparatus is started up, initial driving operations of the devices are completed, the mirror 9 is present on a measurement optical path, and measurement lights are radiated to the model eye 11, as illustrated in FIG. 14, centers of the strips 11v and 11f and a center of an arrangement of the measurement lights coincide with each other in design.

The location of the light scanning unit 6 is a location where the central measurement lights are present with respect to the model eye bottom 11r. That is, when the central measurement light is radiated to a minus coordinate side on the coordinate in a design which does not contain errors, the location of the light scanning unit 6 is also on the minus coordinate side.

When the image rotator 2 according to the present exemplary embodiment is rotated half, the transmitting light is generally rotated, but an amount of rotation of light is set to be an amount of rotation of the image rotator 2 for convenience sake of description. The angle of the image rotator 2 when an arrangement of measurement lights is horizontal with respect to the transverse strip 11f is set to be 0° and the counterclockwise direction is set to be a plus direction.

First, the control unit 23 calculates an inclination between the transverse strip 11f and the scanning direction of the X-axis of the light scanning unit 6 and an inclination between the direction of the arrangement of measurement lights and the X-axis of the light scanning unit 6 while the image rotator 2 is located at 0°, that is, the measurement lights are horizontal with respect to the transverse strip 11f in design.

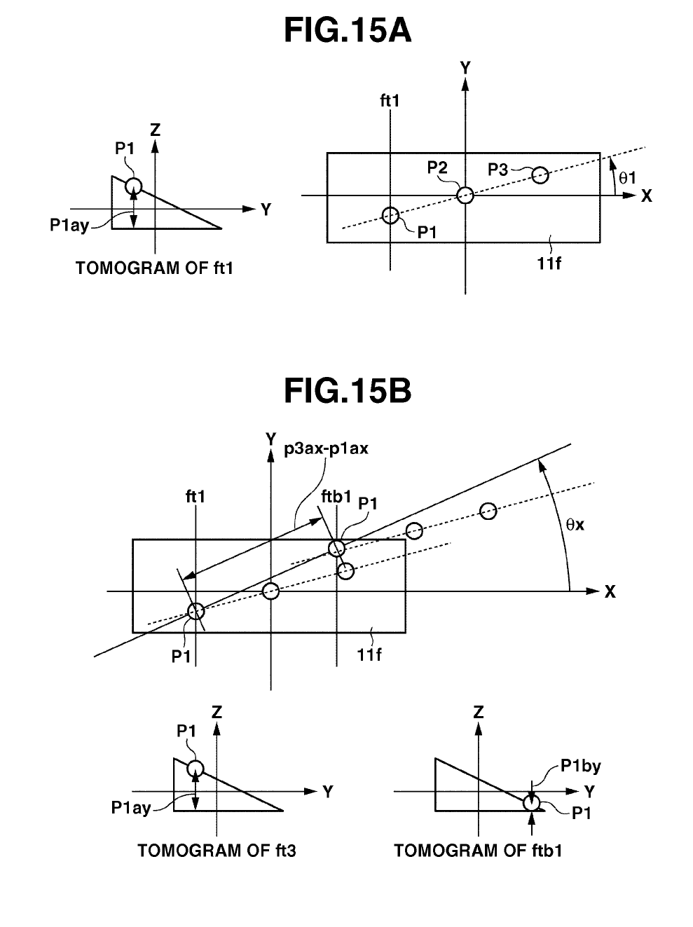

FIGS. 15A and 15B are diagrams illustrating a method of obtaining inclinations of a transverse strip 11f of the model eye, an arrangement of measurement lights, and the light scanning unit 6. The image rotator 2 is located at 0°.

As illustrated in FIG. 15A, the X-axis and the Y-axis of the light scanning unit 6 are fixed to the center of the transverse strip 11f to radiate the measurement lights to the transverse strip 11f. The control unit 23 measures tomograms of the measurement lights P1 and P3, and obtains the locations Play and P3ay in the Y-directions of the measurement lights P1 and P3 from the thicknesses of the tomograms. If locations of the measurement lights P1 and P3 in design is (p1ax, 0), (p3ax, 0)θ, the calculated angle θ1 of the transverse strip 11f and the measurement lights P1 and P3 is obtained by the following equation.

sin(θ1)=(P1ay−P3ay)÷(p1ax−p3ax)

The inclination between the transverse strip 11f and the X-axis of the light scanning unit 6 is obtained by driving the X-axis of the light scanning unit 6. As illustrated in FIG. 15B, the control unit 23 displaces the X-axis of the light scanning unit 6, for example, by (p3ax-p1ax) in this state, obtains a tomogram of the measurement light P1, and obtains a location p1by in the Y-direction of 13 from the thickness of the tomogram.

Accordingly, the inclination θx between the transverse strip 11f and the X-axis of the light scanning unit 6 is obtained by the following equation.

sin(θx)=(P1by−P1ay)÷(p3ax−p1ax)

An inclination θ2 of the scanning direction of the X-axis of the light scanning unit 6 with respect to the measurement lights P1 and P3 is obtained by the following equation.

θ2=θx−θ1

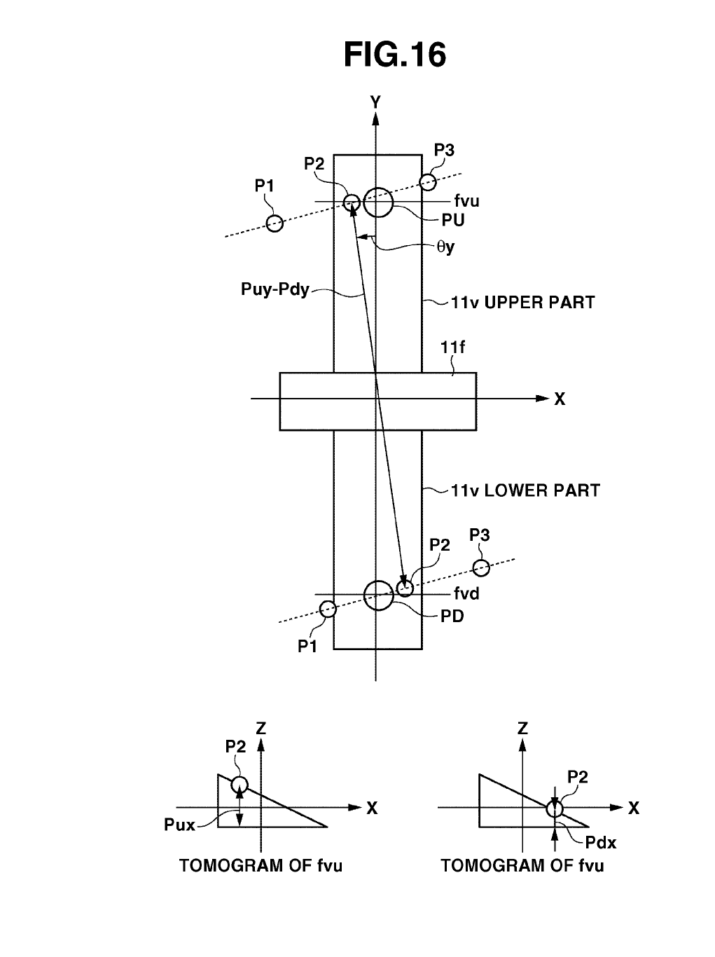

Thereafter, the control unit 23 obtains an inclination between the vertical strip 11v and the scanning direction of the Y-axis of the light scanning unit 6. FIG. 16 is a diagram illustrating a method of obtaining an inclination between the vertical strip 11v and a scanning direction of the Y-axis of the light scanning unit 6.

The control unit fixes the X-axis of the light scanning unit 6 to the center of the vertical strip 11v, and measures the tomogram in the vicinities of PU and PD by using the measurement light P2 in the Y-axis of the light scanning unit 6. PU is located at an upper portion of the vertical strip 11v and PD is located at a lower portion of the vertical strip 11v, and both of them are present at the center of the Y-axis. Like the transverse strip 11f, a thickness of the tomogram varies according to a location where the measurement light is radiated with respect to the X-direction also in the vertical strip 11v, and accordingly, a unique location is obtained according to the thickness.

If the locations of the X-axes obtained from the thicknesses of the tomograms in the vicinities of PU and PD are Pux and Pdx and the measured locations of the Y-axes of the light scanning unit 6 are Puy and Pdy, an angle θy of the scanning direction of the Y-axis of the light scanning unit 6 with respect to the vertical strip 11v is obtained by the following equation.

Sin(θy)=(Pux−Pdx)÷(Puy−Pdy)

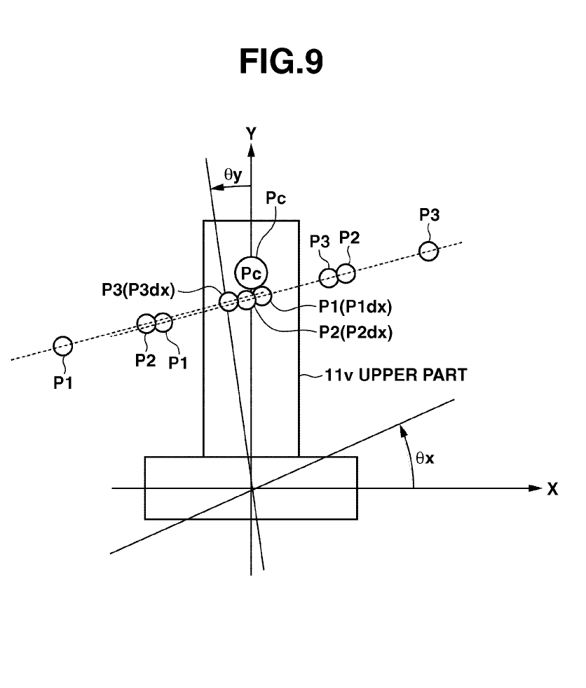

Thereafter, the control unit 23 obtains the distance between the measurement lights P1, P2, and P3. FIG. 9 is a diagram illustrating a method of obtaining the distances between the measurement lights P1, P2, and P3. The control unit 23 displaces the Y-axis of the light scanning unit 6 from the center of the vertical strip 11v to a location where a measurement light is not irradiated to the transverse strip 11f even when the X-axis of the light scanning unit 6 is scanned and where the measurement light is irradiated to the vertical strip 11v when the X-axis of the light scanning unit 6 is scanned.

When the light scanning unit 6 is displaced, the light scanning unit 6 is driven while being corrected with the angles θx and θy formed by the strips 11f and 11v and the light scanning unit 6. The control unit 23 drives the light scanning unit 6 so that the measurement lights P1, P2, and P3 are located on the vertical strip 11v, for example, Pc.

That is, when the location of Pc is (0, Pcy) and the locations of the measurement lights P1, P2, and P3 in design are (p1ax, 0), (p2ax, 0), and (p3ax, 0), if the measurement light P1 is to be radiated to a location in the vicinity of Pc, the light scanning unit 6 needs to be located at (−p1ax, Pcy) in the coordinate system of the model eye bottom 11r. If the coordinate system of the model eye bottom 11r is converted into the coordinate system (X1, Y1) of the light scanning unit 6, the following equation is obtained. The control unit 23 drives the light scanning unit 6 to a location of (X1, Y1).

$$X 1 = \frac{Bx}{T + 1} \times \sqrt{1 + {( tan θ y )}^{2}} \\ Y 1 = \frac{By}{T + 1} \times \sqrt{1 + {( tan θ x )}^{2}} \\ where \\ T = tan θ x \times tan θ y \\ Bx = - p 1 ax + Pcy \times tan θ y \\ By = Pcy + p 11 x \times tan θ x \qquad [ Equation 8 ]$$

In this state, the control unit 23 measures a tomogram with the measurement light P1, and obtains a location P1dx of the X-direction on the vertical strip 11v from the obtained thickness tp1 of the tomogram. Further, in this state, the control unit 23 drives the light scanning axis by (p1ax-p2ax) in the direction of the above-obtained approximate inclination θ1 of the measurement light.

That is, the control unit 23 drives the light scanning axis so that the measurement light P2 is located on Pc. The light scanning unit 6 is driven from a state where the tomogram is measured with the measurement light P1. Then, the control unit 23 measures a tomogram with the measurement lights P2, and obtains a location P2dx of the X-direction on the vertical strip 11v from the obtained thickness tp2 of the tomogram.

$$Y \text{-} axis \text{:} ( p 1 ax - p 2 ax ) = \frac{\sqrt{{( tan ( θ y - θ 1 ) \times tan ( θ x - θ 1 ) )}^{2} + {( tan ( θ x - θ 1 ) )}^{2}}}{1 + tan ( θ y - θ 1 ) \times tan ( θ x - θ 1 )} \\ X \text{-} axis \text{:} ( p 1 ax - p 2 ax ) = \frac{\sqrt{1 + {( tan ( θ x - θ 1 ) )}^{2}}}{1 + tan ( θ y - θ 1 ) \times tan ( θ x - θ 1 )} \qquad [ Equation 9 ]$$

Similarly, from this state, the control unit 23 drives the light scanning unit 6 in the direction of the approximate inclination θ1 by (p2ax-p3ax) of the measurement light to radiate the measurement light P3 to a location of Pc. The control unit 23 measures a tomogram with the measurement light P3, and obtains a location P3dx of the X-direction on the vertical strip 11v from the obtained thickness tp3 of the tomogram.

If a distance between the measurement lights P1 and P2 is p12xl, a distance between the measurement lights P2 and P3 is p23xl, and a distance between the measurement lights P1 and P3 is p13xl, as the distances in the direction connecting the measurement lights P1 and P3, the distances are obtained by the following equation.

P12xl=p2ax−p1ax−((p2dx−p1dx)÷cos θ1)

P23xl=p3ax−p2ax−((p3dx−p2dx)÷cos θ1)

P13xl=p3ax−p1ax−((p3dx−p1dx)÷cos θ1)

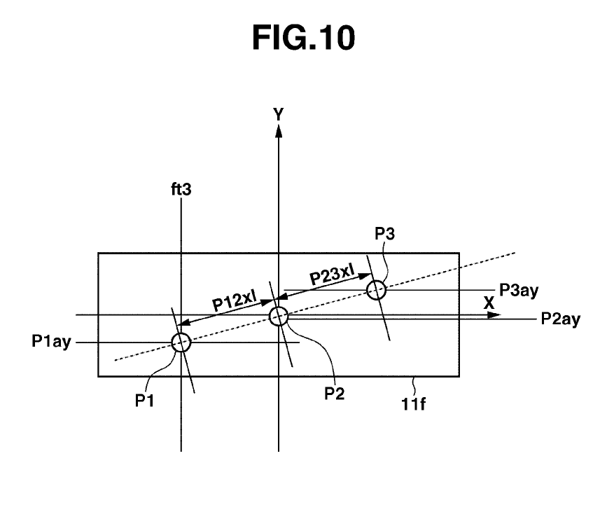

FIG. 10 is a diagram illustrating a method of obtaining an arrangement of measurement lights. If the light scanning unit 6 is located at a center of the transverse strip 11f, the measurement lights P1, P2, and P3 are radiated to the transverse strip 11f, and the tomograms are measured, an angle θf the arrangement of the measurement lights with respect to the transverse strip 11f is obtained through the least squares method while the measurement lights P1, P2, and P3 have the following location relationship with respect to the transverse strip 11f, from the locations P1ya, P2ya, and P3ya of the X-direction with respect to the transverse strip 11f obtained from the thicknesses of the tomograms at the locations to which the measurement lights P1, P2, and P3 are radiated.

(−P12xl×cos(θ12),P1ya),(0,P2ya),(P23xl×cos(θ23),P3ya)

where, sin(θ12)=(P2ya−P1ya)÷P12xl, sin(θ23)=(P3ya−P2ya)÷P23xl

Accordingly, an inclination θx of the X-axis of the light scanning unit 6 with respect to the transverse strip 11f which is a reference of the X coordinate, an inclination θy of the Y-axis of the light scanning unit 6 with respect to the vertical strip 11v which is a reference of the Y-axis, and an inclination θf the arrangement of the measurement lights when the image rotator 2 with respect to the transverse strip 11f which is a reference of the X coordinate intends to make the arrangement of the measurement lights horizontal to the transverse strip 11f are obtained.

Thereafter, a rotation center location of the image rotator 2 is obtained. FIG. 11 is a diagram illustrating a method of obtaining the rotation center location of the image rotator 2. The control unit 23 rotates the image rotator 2 so that the light scanning unit 6 is located at the center of the transverse strip 11f and the measurement light P1 is located on the transverse strip 11f.

Then, the control unit 23 measures a tomogram with the measurement light P1, and obtains a location Plly in the Y-direction on the transverse strip 11f of the measurement light P1 from the thickness of the tomogram. From this state, the control unit 23 rotates the image rotator 2 by 180°.

The control unit 23 measures a tomogram of the transverse strip 11f with the measurement light P1, and obtains a location p1ry of the Y-direction on the transverse strip 11f from the thickness of the tomogram. From this state, the control unit 23 rotates the image rotator 2 so that the measurement light P1 is located at an upper portion of the vertical strip 11v.

The control unit 23 measures a tomogram with the measurement light P1, and obtains a location p1ux of the X-direction on the vertical strip 11v from the thickness of the tomogram. From this state, the control unit 23 rotates the image rotator 2 by 180°.

The control unit 23 measures a tomogram of the vertical strip 11v with the measurement light P1, and obtains a location p1dx of the X-direction on the vertical strip 11v from the thickness of the tomogram. A rotation center location RC of the image rotator 2 is obtained by the following equation.

RC=((p1ux+p1dx)÷2,(p1ly+p1ry)÷2)

In the present exemplary embodiment, the image rotator 2 serves as a mechanism for changing the inclination of the arrangement of the measurement lights. However, in the present exemplary embodiment, the image rotator 2 is driven only when the arrangement of the measurement lights is initially set to be horizontal and the rotation center location of the image rotator 2 is obtained.

Thus, when a mechanism for changing an angle of the arrangement of the measurement lights is not present and the arrangement of the measurement lights is fixed to the transverse strip 11f, and if the process of obtaining a rotation center location of the image rotator 2 is omitted, the inclination of the scanning axis of the light scanning unit 6 with respect to the angle of the arrangement of the measurement lights can be obtained.

Although the measured location is based on the coordinate of the model eye bottom 11r, a relationship of a location where the mirror 9 is not present on the measurement optical path and the measurement light is radiated onto the eyepiece lens 7b, and a location where the mirror 9 is present on the measurement optical path and the measurement light is radiated onto the model eye bottom 11r is defined. Accordingly, a location can be corrected as the coordinate on the fundus 8r by matching the coordinate system of the location of the model eye bottom 11r with the coordinate system of the eyepiece lens 7b.

As described above, the model eye 11 where the detected thickness of the tomogram varies according to a location to which the measurement light is radiated, and whose location is obtained with respect to a direction of a reference axis according to the thickness of the tomogram is used. Accordingly, an inclination of the light scanning unit 6 with respect to the arrangement of the measurement lights is obtained from a location of the light scanning unit 6 and a location on the model eye corresponding to the thickness of the tomogram measured in the location of the light scanning unit 6.

Since the scanning direction of the light scanning unit 6 can be matched with the arrangement of the measurement lights from the inclination, an adjustment needs not be performed precisely during an assembly process. Further, even when a displacement is generated due to a temporal change or an impact, the scanning direction of the light scanning unit 6 with respect to the arrangement of the measurement lights can be corrected.

Thus, a width of the measurement lights with respect to the scanning direction produced by the measurement lights can be reduced. Further, by measuring the location relationship of the measurement lights, it can be seen how much the measurement lights are displaced from design values. Thus, the data arrays can be averaged at the same measurement sites of the measured object where each measurement light radiates by displacing the image by the displacement. Accordingly, in the tandem scanning operation, an optical tomogram with a high SN ratio can be obtained.

Next, a fourth exemplary embodiment of the present invention will be described. FIG. 13B is a diagram illustrating a configuration of an optical coherence tomography apparatus according to the fourth exemplary embodiment of the present invention. In the present exemplary embodiment, an imaging apparatus using a Fourier domain type optical coherence tomography will be exemplified. The difference between the first exemplary embodiment and the fourth exemplary embodiment lies in that a fiber connector 36 capable of driving locations of measurement lights is provided, instead of the fiber connector 35 connected to the sample arm 1001.

FIG. 2B is a diagram illustrating a configuration of the fiber connector 36 according to the present exemplary embodiment, and is a diagram where the fiber connector 36 is viewed from the fiber end. The connector 36 is fixed to the sample arm 1001. The measurement lights enter the sample arm 1001 with an arrangement of fiber ends 35i, 35j, and 35k corresponding to the optical fibers 34, respectively.

The locations of the fiber ends 35i, 35j, and 35k can be adjusted in the upward, downward, left, and right directions of FIG. 2B by drive units 36a, 36b, and 36c and are driven under the control of the control unit 23. The fiber ends may be configured to be changed in a three-dimensional direction with the location relationships being independent.

In the first exemplary embodiment, the light scanning unit 6 and the image rotator 2 are driven, and then as illustrated in FIGS. 5D and 6C, the locations P1A, P2A, and P3A of the measurement lights are obtained based on the locations of the measurement lights entering the line sensor L.

In the present exemplary embodiment, the drive units 36a, 36b, and 36c are driven from the locations of the measurement lights, and the locations of the measurement lights are corrected so such a manner that the arrangement of the fiber ends 35i, 35j, and 35k is disposed at a location in design or are aligned linear, so that a width of the measurement lights with respect to the scanning direction produced by the measurement lights can be restrained to an infinitesimal range. Accordingly, in the tandem scanning operation, an optical tomogram with a high SN ratio can be obtained.

In the present exemplary embodiment, the three measurement lights are exemplified, but all of the drive units 36a, 36b, and 36c may not be driven, and at least one of them may be driven.

In the present exemplary embodiment, although the fiber connector 35 of the first exemplary embodiment is replaced with the fiber connector 36 capable of changing the arrangement location of the measurement lights, it is also the same in the second and third exemplary embodiments, the locations of the measurement lights can be corrected by replacing the fiber connector 35 with the fiber connector 36 capable of changing the arrangement location of the measurement lights.

In the second exemplary embodiment, the drive units 36a, 36b, and 36c are driven based on the locations P1B, P2B, and P3B of the measurement lights obtained by Equation 6, and the locations of the measurement lights are corrected or are made linear so that the arrangement of the fiber ends 35i, 35j, and 35k is disposed at a location in design, so that a width of the measurement lights with respect to the scanning direction produced by the measurement lights can be restrained to an infinitesimal range.

In the third exemplary embodiment, the drive units 36a, 36b, and 36c are driven based on the locations P1, P2, and P3 of the measurement lights obtained in FIG. 10, and the locations of the measurement lights are corrected or are made linear so that the arrangement of the fiber ends 35i, 35j, and 35k is disposed at a location in design, so that a width of the measurement lights with respect to the scanning direction produced by the measurement lights can be restrained to an infinitesimal range.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2011-146342 filed Jun. 30, 2011 and No. 2012-089354 filed Apr. 10, 2012, which are hereby incorporated by reference herein in their entirety.

What is claimed is:

1. An imaging apparatus that acquires an image of an object to be examined based on a plurality of lights returning from the object to be examined to which a plurality of measurement lights is radiated, the imaging apparatus comprising:
a scanning unit configured to scan the object to be examined with the plurality of measurement lights;
a detection unit configured to detect an arrangement of the plurality of measurement lights returned from the object to be examined; and
an arrangement adjusting unit configured to adjust the arrangement with respect to a scanning direction of the scanning unit based on a detection result of the detection unit.

2. The imaging apparatus according to claim 1, wherein the arrangement adjusting unit adjusts a location of the arrangement based on the scanning direction and the detected arrangement.

3. The imaging apparatus according to claim 1, further comprising:
a division unit configured to divide the plurality of measurement lights to optical paths of the detection unit; and
a control unit configured to, after the arrangement adjusting unit adjusts the arrangement, remove the division unit from the optical paths.

4. The imaging apparatus according to claim 1, further comprising:
a calculation unit configured to calculate the angle of the arrangement with respect to the scanning direction of the scanning unit based on a detection result of the detection unit.

5. The imaging apparatus according to claim 1, wherein the detection unit detects radiation locations of the plurality of measurement lights on the object to be examined.

6. The imaging apparatus according to claim 1, further comprising:
a tomogram acquiring unit configured to acquire a tomogram of the object to be examined, based on a plurality of combined lights obtained by adding the plurality of returning lights and a plurality of reference lights corresponding to the plurality of measurement lights, respectively.

7. The imaging apparatus according to claim 1, further comprising:
a calculation unit configured to calculate relationships of locations of the plurality of measurement lights, an angle of the arrangement of the plurality of measurement lights, and a scanning angle of the scanning unit, based on locations of the plurality of measurement lights detected by the detection unit, a location of the adjusting unit, and a location of the scanning unit.

8. The imaging apparatus according to claim 7, wherein the detection unit detects locations of the plurality of measurement lights in a one-dimensional direction.

9. The imaging apparatus according to claim 1, further comprising:
a calculation unit configured to calculate relationships of locations of the plurality of measurement lights, an angle of the arrangement of the plurality of measurement lights, and a scanning angle of the scanning unit, based on locations of the plurality of measurement lights detected by the detection unit, and a location of the scanning unit.

10. The imaging apparatus according to claim 9, wherein the detection unit detects the locations of the plurality of measurement lights in a one-dimensional direction, and the relationships of the locations of the plurality of measurement lights, the angle of the arrangement of the plurality of measurement lights, and the scanning angle of the scanning unit are the angle of the arrangement of the plurality of measurement lights with respect to the scanning axis of the scanning unit.

11. An optical coherence tomography apparatus in which a plurality of lights radiated from a light source is branched into measurement lights and reference lights, respectively, and the measurement lights are guided to an object to be examined and the reference lights are guided to reference mirrors, configured to capture a tomogram of the object to be examined based on lights returning from the object to be examined and reflected lights from the reference mirrors, the apparatus comprising:
an adjusting unit configured to adjust an angle of an arrangement of the plurality of measurement lights arranged on a line;
a scanning unit configured to scan the object to be examined with the plurality of measurement lights the arrangement which angle has been adjusted by the adjusting unit;
a first measurement unit configured to measure a tomogram of a detection model disposed at a location optically corresponding to the object to be examined and whose tomogram can be measured, by driving the adjusting unit and the scanning unit;
a measuring unit configured to measure the locations of the plurality of measurement lights from a thickness of the tomogram of the detection model measured by the measurement unit; and
a calculation unit configured to calculate a relationship of locations of the plurality of measurement lights, an angle of the arrangement of the plurality of measurement lights, and a scanning angle of the scanning unit, based on the locations of the plurality of measurement lights measured by the measuring unit, a location of the adjusting unit, and a location of the scanning unit.

12. An optical coherence tomography apparatus in which a plurality of lights radiated from a light source is branched into measurement lights and reference lights, respectively, and the measurement lights are guided to an object to be examined and the reference lights are guided to reference mirrors, configured to capture a tomogram of the object to be examined based on lights returning from the object to be examined and reflected lights from the reference mirrors, the apparatus comprising:
a scanning unit configured to scan a plurality of measurement lights arranged in a line;
a measurement unit configured to measure a tomogram of a detection model disposed at a location optically corresponding to the object to be examined and whose tomogram can be measured, by driving the scanning unit;
a measuring unit configured to measure the locations of the plurality of measurement lights from thicknesses of the tomogram of the detection model measured by the measurement unit; and
a calculation unit configured to calculate a relationship of locations of the plurality of measurement lights, an angle of the arrangement of the plurality of measurement lights, and a scanning angle of the scanning unit, based on the locations of the plurality of measurement lights determined by the determination unit, and a location of the scanning unit.

13. The optical coherence tomography apparatus according to claim 12, wherein the detection model has two axes orthogonal to a tomography structure in which thickness of the tomogram to be measured is different depending on locations to which the plurality of measurement lights is radiated, and locations to which the plurality of measurement lights is radiated are uniquely determined based on difference in thickness of the tomogram.

14. The optical coherence tomography apparatus according to claim 7, further comprising:
a correction unit configured to correct an amount of drive of the scanning unit, based on a displacement of an inclination of a scanning axis of the scanning unit with respect to the angle of the arrangement of the plurality of measurement lights.

15. The optical coherent tomography apparatus according to claim 7, further comprising:
a selection unit configured to select data of a tomogram measured at a same location by the plurality of measurement lights and averaged, based on the locations of the plurality of measurement lights.
